(19) United States
(12) Patent Application Publication
(10) Pub. No.: US 2005/0168577 A1
(43) Pub. Date: Aug. 4, 2005

(54) Digital camera

(75) Inventors: Toshihiko Karasaki, Kawachinagano-shi (JP); Hitoshi Hagimori, Ikoma-gun (JP); Yong Xin Huang, Kobe-shi (JP); Masahito Niikawa, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/008,383

(22) Filed: Dec. 9, 2004

(30) Foreign Application Priority Data
Feb. 2, 2004 (JP) JP2004-025336

(51) Int. Cl. H04N 5/225

(52) U.S. Cl. 348/207.2; 348/231.2; 348/231.7; 348/231.3

(57) ABSTRACT

The present invention provides a digital camera capable of excellently recording a print order file on a recording medium and normally performing a print setting operation even in the case where a recording medium is replaced during the print setting operation. In a digital camera for recording a captured image on a removable recording medium, each time a print setting is made on an image recorded in a memory card by an operation for an operating member, a print order file to be recorded on the memory card is updated. At the time of displaying the total number of prints and a charge for printing on an LCD, the print order file recorded on the memory card is read and, on the basis of the information recorded in the print order file, the total number of prints and the charge for printing are displayed.

This application is based on application No. 2004-025336 filed in Japan, the contents of which are hereby incorporated by reference.

### BACKGROUND OF THE INVENTION

1. Field of the Invention

The present invention relates to a digital camera (electronic image capturing apparatus) into which a removable recording medium for recording a captured image can be inserted.

2. Description of the Background Art

Conventionally, there is a technique of capturing an image of a subject by using a digital camera into which a removable recording medium can be inserted, setting printing of the image recorded on the recording medium by operating the digital camera, and recording a print order file called a DPOF (Digital Print Order Format) (registered trademark) file or the like on the recording medium. In such a technique, the user takes out the recording medium on which the print order file is written from the digital camera and brings it to a print service shop or the like. In the print service shop, a process of reading the print order file recorded on the recording medium and printing the image stored in the recording medium on the basis of print settings for each of the images included in the file is performed.

There is also a technique of displaying the total number of prints, charges for printing, and the like to the user at the time of setting printing on an image by using the digital camera.

However, generally, a conventional digital camera records a print order file on a recording medium or updates a print order file already recorded at the time when an operation of making print settings for a plurality of images stored in the recording medium is finished and an operation for determining the print settings is performed.

Consequently, even if the total number of prints, charges, and the like are displayed during a print setting operation as descried in the above publication, there is a case that the information is not reflected in a print order file on a recording medium. If an operation of replacing the recording medium is performed at that stage, a problem occurs such that the print settings which have been inputted are not recorded on the recording medium.

When the determining operation is performed after the recording medium is replaced, there is the possibility in that a print order file is recorded in a state where print settings which were made before the replacement of the recording medium are also included. In this case, the print settings for an image which is not recorded on the recording medium are recorded and it causes discrepancy between the print settings and the image, and there is occurred a problem such that an accurate printing process cannot be performed.

If the total number of prints, charges, and the like which were set for the previous recording medium are displayed even after the recording medium was replaced, the print setting information of an image which does not exist on the recording medium with which the previous recording medium was replaced, and there is also occurred a problem such that proper information of the presently inserted recording medium cannot be recognized.

As described above, in the conventional digital camera which can make print settings, when a work of replacing a recording medium is performed during a print setting operation, various problems occur. Consequently, the conventional digital camera is constructed so as not to be able to perform the replacing work during the print setting operation.

Further, in the conventional digital camera which can make print settings, also in the case where a power source battery is exhausted during the print setting operation, a print order file cannot be recorded on a recording medium, and a problem occurs such that the print setting operation performed until then is wasted.

### SUMMARY OF THE INVENTION

An object of the present invention is to provide a digital camera capable of excellently recording a print order file on a recording medium and normally performing a print setting operation even in the case where a recording medium is replaced during the print setting operation.

The present invention is directed to a digital camera capable of recording a captured image on a removable recording medium.

According to an aspect of the present invention, the digital camera comprises: a display for displaying an image; an operating member for inputting a command; a print setting part for updating a print order file to be recorded on the recording medium each time a print setting is made on an image recorded on the recording medium by using the operating member; and a display controller for reading the print order file from the recording medium and displaying an order content on the display on the basis of information recorded in the print order file.

In the digital camera according to this aspect, each time a print setting is made on an image recorded on a recording medium, a print order file recorded on the recording medium is updated. Consequently, even in the case where the recording medium is replaced during the print setting operation, the print order file based on the print setting operation performed until then is recorded excellently also on the recording medium which has been taken out. Since a print order file to be recorded on a recording medium is updated each time a print setting is made on an image, even in the case where a power source battery is exhausted during the print setting operation, the print order file can be excellently recorded on the recording medium before exhaustion of the power source battery.

According to another aspect of the present invention, a digital camera comprises: a display for displaying an image; an operating member for inputting a command; a print setting part for recording a print order file on the recording medium on the basis of input information supplied by a print setting operation using the operating member; and a display controller for displaying a print setting screen on the display when the print setting operation is performed, reading the print order file from the recording medium interlockingly with insertion of the recording medium when the recording medium is replaced during display of the print setting screen, and displaying an order content in the print setting screen on the basis of information recorded in the print order file.

In the digital camera according to this aspect, even in the case where a recording medium is replaced, the print setting screen is displayed on the basis of the print order file recorded on the recording medium interlockingly with insertion of the recording medium. Consequently, even after replacement of the recording medium, the print setting operation can be performed normally. Particularly, by displaying the total number of prints and a charge for printing on the display on the basis of the print order file recorded on the recording medium, after replacement of the recording medium, a print setting state recorded on a recording medium with which the recording medium was replaced can be displayed accurately on the display. Thus, the print setting operation can be normally continued.

As described above, according to the present invention, a recording medium can be normally replaced even during the print setting operation.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the outside configuration of a digital camera according to a preferred embodiment of the present invention;

FIG. 2 is a diagram showing the outside configuration of the digital camera;

FIG. 3 is a diagram showing the inside configuration of the digital camera;

FIG. 4 is a diagram showing a data sequence in a memory card;

FIG. 5 is a diagram illustrating a print order file;

FIG. 6 is a diagram illustrating the print order file;

FIG. 7 is a diagram illustrating a print setting screen;

FIG. 8 is a diagram illustrating the print setting screen;

FIG. 9 is a diagram showing operations in a print mode;

FIG. 10 is a diagram showing operations in the print mode;

FIG. 11 is a diagram showing operations in the print mode;

FIG. 12 is a diagram illustrating operations in the print mode;

FIG. 13 is a diagram illustrating an enlarged print preview screen;

FIG. 14 is a flowchart showing operations of print order recording;

FIG. 15 is a diagram illustrating a print menu screen;

FIG. 16 is a diagram showing items displayed on the print menu screen;

FIGS. 17A to 17D are diagrams illustrating displays regarding the print mode;

FIG. 18 is a diagram showing operations of print initial setting;

FIG. 19 is a diagram showing operations of print total number display setting;

FIG. 20 is a diagram showing operations of print total number display setting;

FIG. 21 is a state transition diagram showing basic operations of the digital camera;

FIG. 22 is a diagram showing the relation between the print mode and other four kinds of modes;

FIG. 23 is a flowchart showing error check operation;

FIG. 24 is a diagram showing operations of the digital camera in the case where a memory card replacing operation is performed;

FIG. 25 is a diagram showing the operations of the digital camera in the case where the memory card replacing operation is performed;

FIGS. 26A to 26D are diagrams each showing a screen of warning displayed when a memory card is not inserted;

FIGS. 27A to 27D are diagrams each showing a screen of warning displayed in the case where a captured image is not recorded on the memory card;

FIGS. 28A to 28D are diagrams each showing a print setting screen displayed in the case where no print order file is recorded on the memory card; and

FIGS. 29A to 29D are diagrams each showing a print setting screen displayed in the case where a print order file is recorded on the memory card.

### DESCRIPTION OF THE PREFERRED EMBODIMENTS

Hereinafter, preferred embodiments of the present invention will be described with reference to the drawings.

Outline of Configuration

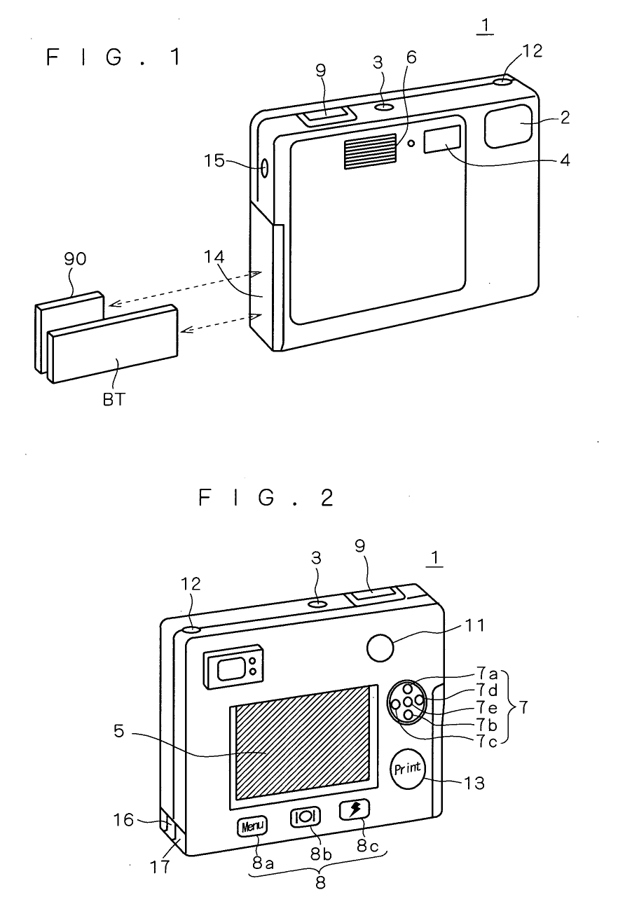

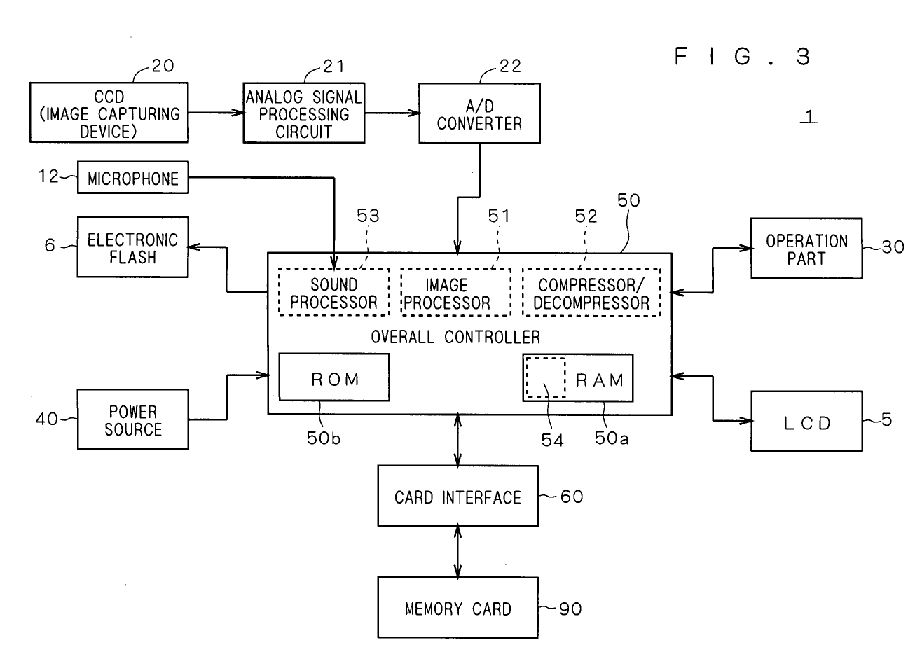

FIGS. 1 and 2 are diagrams showing the outside configuration of a digital camera I according to a preferred embodiment of the present invention. FIG. 1 is a schematic perspective view from the front side and FIG. 2 is a schematic perspective view from the rear side.

As shown in FIGS. 1 and 2, the digital camera 1 is thin and has an almost rectangular parallelepiped shape.

As shown in FIG. 1, the digital camera 1 has, on its front face side, a taking lens 2, an optical viewfinder 4 and an electronic flash 6, and has, on its top face side, a power source button 3, a shutter button (release button) 9 and a microphone 12. As shown in FIG. 2, the digital camera 1 has, on its rear face side, a liquid crystal display (hereinafter, referred to as LCD) 5, button groups 7 and 8, a mode switching button 11 and a print button 13. The button group 7 is constructed by cross cursor buttons 7a to 7e (hereinafter, also referred to as up button 7a, down button 7b, left button 7c, right button 7d and center (execution) button 7e). The button group 8 has a menu button 8a, a liquid crystal monitor button 8b and an electronic flash mode button 8c. Further, as shown in FIGS. 1 and 2, the digital camera 1 also has, on its side faces, a cover 14, a DC input terminal 15, a USB terminal 16 and an AV output terminal 17.

As will be described later, the digital camera 1 obtains image data of a subject by photoelectrically converting an image of the subject from the taking lens 2 in a CCD (Charge Coupled Device) 20 (FIG. 3).

The power source button 3 is used for accepting an operation of turning on/off the power source. Concretely, each time the power source button 3 is depressed, the power source is switched between the ON and OFF states.

The shutter button 9 is a two-level press switch capable of detecting a half-pressed state (hereinafter, also referred to as an SI state) and a depressed state (hereinafter, also referred to as an S2 state) set by=the user (operator). In the=half-pressed (SI) state, automatic focus control is started. In the depressed (S2) state, image capturing operation for capturing an image to be recorded is started.

The LCD 5 performs preview display (also referred to as live view display) before the image capturing operation and playback and display of a recorded image. The LCD 5 has a predetermined number of display pixels (in this case, 320×240) and can display a color image. The LCD 5 functions as a display part capable of displaying an image captured in an image capturing mode (which will be described later) and recorded, various setting screens, and the like.

After the power source of the digital camera 1 is turned on or the image capturing operation is completed, in the live view display, capturing of an image of the subject is repeated at low resolution every 1/30 second and the captured image is displayed in a motion picture mode on the LCD 5. By the live view display on the LCD 5, the user can perceive the position, size and the like of the subject in the captured image and perform framing operation. The framing operation can be also performed by using only the optical viewfinder 4 without using the LCD 5.

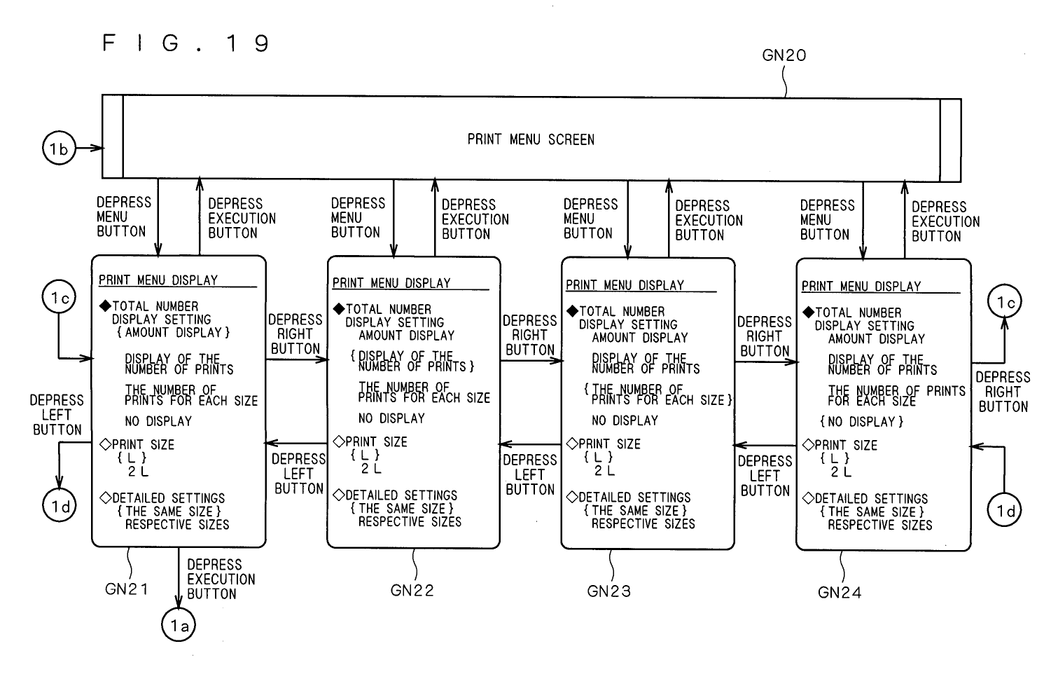

By depressing the mode switching button 11, the mode is cyclically switched among the single frame shooting mode, continuous shooting mode, motion picture mode and playback mode (see FIG. 22). The single frame shooting mode, continuous shooting mode and motion picture mode are included in the image capturing mode. The image capturing mode is a mode of capturing a still image or a motion picture, and the playback mode is a mode of playing back a captured image recorded on a memory card and displaying the image played back on the LCD 5. The digital camera 1 of the preferred embodiment is set in the image capturing mode at the turn-on of the power source by depression of the power source button 3. By depressing the mode switching button 11, the mode can be switched to the playback mode. By further depressing the mode switching button 11, the mode is switched to the single frame shooting mode in the image capturing mode.

The menu button 8a has a function of switching between display and non-display of a menu on the LCD 5. For example, each time the menu button 8a is depressed in the initial screen of any operation mode, a menu screen and a screen without a menu (display screen of a live view, an image played back or the like) are alternately displayed on the LCD 5. A display cursor in the menu screen displayed on the LCD 5 can be moved in four ways by using the cross cursor buttons 7a to 7d. Further, by depressing the execution (center) button 7e in the state where a desired option is selected, a setting operation or the like corresponding to the option can be executed. By such operation, various image capturing parameters can be set.

The liquid crystal monitor button 8b is a button for switching the state between display and non-display of an image on the LCD 5 as a liquid crystal monitor. Each time the liquid crystal monitor button 8b is depressed, a state where an image or the like is displayed (display state) and a state where no image is displayed (non-display state) are alternately switched. In the non-display state, power consumption can be decreased.

The electronic flash mode button 8c is a button for determining the mode of the electronic flash 6. Each time the electronic flash mode button 8c is depressed, the electronic flash mode is switched to an automatic electronic flash mode, a forced electronic flash mode and an electronic flash inhibited mode in this order.

The microphone 12 is used for obtaining (recording) sound data at the time of motion picture capturing, voice memo, voice recording and after-recording.

The print button 13 is a button for shifting the operation mode of the digital camera to a print mode. In the print mode, print settings are made for a captured image which is recorded on a memory card 90.

The cover 14 is provided in a portion to cover a battery chamber and a memory card insertion part. In other words, on the inside of the cover 14, a battery chamber for housing a power source battery BT and a memory card insertion part in which a memory card 90 as a detachable recording medium (portable recording medium) is inserted are provided. The power source battery BT and the memory card 90 are detachably inserted in the battery chamber and the memory card insertion part, respectively. Image data and the like obtained by the image capturing operation is recorded on the memory card 90 which is inserted into the insertion part. The digital camera 1 can receive power supply from the power source battery BT and power supply from an AC adapter (not shown) or the like by using the DC input terminal 15.

The USB terminal 16 is a terminal for performing data communication with a personal computer. By connecting a USB standard cable or the like to the USB terminal 16, data communication can be performed with an external apparatus (personal computer or the like).

The AV output terminal 17 is a terminal for connecting the digital camera 1 to an external audio visual apparatus (AV apparatus) such as a television. By connecting the AV output terminal 17 and an input terminal of the external AV apparatus via a predetermined AV code, an image and/or sound can be outputted to the external AV apparatus.

The inside configuration of the digital camera 1 will now be described with reference to FIG. 3. FIG. 3 is a block diagram showing the internal functions of the digital camera 1.

The CCD (image capturing device) 20 functions as image capturing means for capturing an image of a subject and generating an electronic image signal and has, for example, 1600×1200 pixels. The CCD 20 photoelectrically converts a light image of the subject formed by the taking lens 2 into an image signal of color components of R (red), G (green) and B (blue) on a pixel unit basis (signal constructed by a signal sequence of pixel signals received by the pixels) and outputs the image signal.

The image signal obtained from the CCD 20 is supplied to an analog signal processing circuit 21 where the image signal (analog signal) is subjected to predetermined analog signal processes. The analog signal processing circuit 21 has a correlated double sampling (CDS) circuit and an auto gain control (AGC) circuit. A process of reducing noise in the image signal is performed by the CDS circuit and the gain is adjusted by the AGC circuit, thereby performing level adjustment of the image signal.

An A/D converter 22 converts each of pixel signals of the image signal into a digital signal of 12 bits. The digital signal obtained by the conversion is temporarily stored as image data into a buffer memory 54 in an RAM 50a. On the image data stored in the buffer memory 54, WB (White Balance) process, γ correcting process, color correcting process and the like are performed by an image processor 51, and the processed data is subjected to compressing process or the like in a compressor/decompressor 52.

A sound signal obtained from the microphone 12 is inputted to a sound processor 53. The sound signal inputted to the sound processor 53 is converted by an A/D converter (not shown) provided in the sound processor 53 into a digital signal, and the digital signal is temporarily stored in the buffer memory 54.

An operation part 30 is an operation part including the power source button 3, button groups 7 and 8, shutter button 9 and mode switching button 11 and is used by the user to perform an operation of changing the setting state of the digital camera 1, an image capturing operation, and the like.

A power source 40 is a power supply source for the digital camera 1. The digital camera 1 is driven by using a secondary battery such as a lithium ion battery as the power source battery BT.

An overall controller 50 is constructed by a microcomputer having therein the RAM 50a and a ROM 50b and controls the above-described components in a centralized manner when the microcomputer executes a predetermined program. The RAM 50a is a semiconductor memory which can be accessed at high speed (for example, DRAM). The ROM 50b is an electrically rewritable nonvolatile semiconductor memory (for example, an electronic flash ROM). A region in a part of the RAM 50a functions as a buffer area for temporary storage. Herein, the buffer area is also referred to as the buffer memory 54. The buffer memory 54 temporarily stores image data and sound data.

The overall controller 50 has the image processor 51, compressor/decompressor 52 and sound processor 53. The processors 51, 52 and 53 are a function part realized when the microcomputer executes a predetermined program. An operation in the print mode, which will be described later, is also an operation realized when the overall controller 50 executes the predetermined program.

The image processor 51 is a processor for performing various digital image processes such as WB process and y correcting process. The WB process is a process for performing level conversion of each of the color components of R, G and B and adjusting color balance. The y correcting process is a process for correcting the tone of pixel data. The compressor/decompressor 52 is a processor for performing a process of compressing/decompressing image data. As a compressing method, for example, the JPEG system is employed. The sound processor 53 is a processor for performing various digital processes on sound data.

By the overall controller 50 having such a configuration, processes are performed in the image capturing mode, playback mode and print mode. For example, when the shutter button 9 is half-pressed (S1 state) by the user in the image capturing mode, an AF evaluation value for automatic focusing control (AF) is obtained on the basis of image data outputted from the CCD 20, and the taking lens is moved to a focus position by a known hill-climbing method. On the basis of luminance information of the subject read by the CCD 20, shutter speed, an f-number value, and a gain set value of auto white balance at the time of image capturing are determined.

On the other hand, when the shutter button is depressed (S2 state) in the image capturing mode, the overall controller 50 sets the resolution of the CCD 20 to high resolution, captures an image of a subject, and generates a compressed image by the compressor/decompressor 52 on the basis of image data captured by the CCD 20. The compressed high-resolution image data is recorded on the memory card 90 functioning as a recording medium. The data structure in the memory card 90 will be described below.

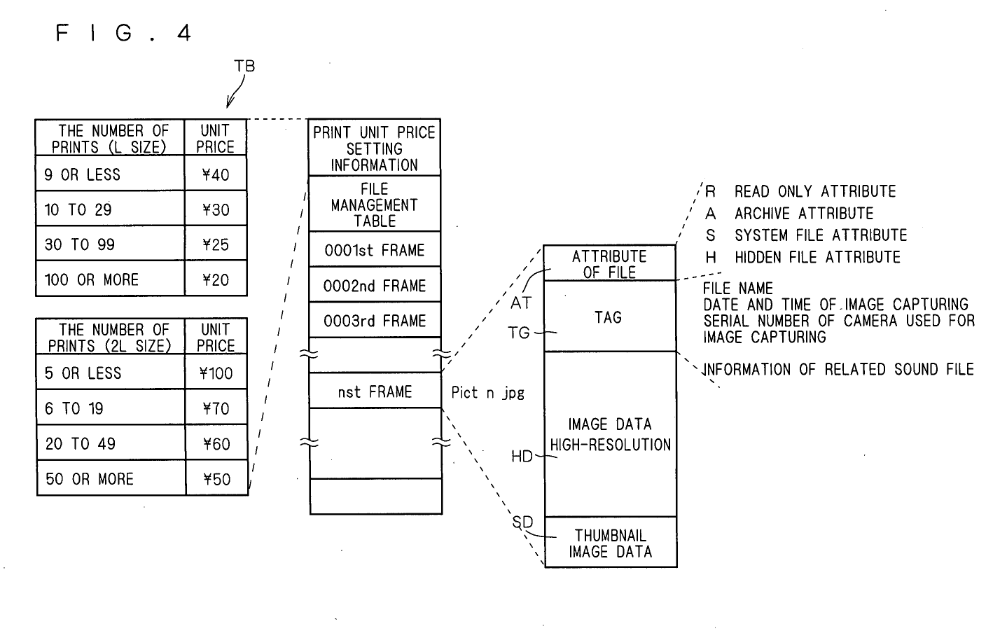

FIG. 4 is a diagram showing a data sequence of the memory card 90. In the memory card 90, frames of a still picture and a motion picture recorded by the digital camera 1 are stored sequentially. In each frame, a file attribute AT, tag information TG, high-resolution image data HD (1600×1200 pixels) compressed in the JPEG format, and thumbnail image data SD (320×240 pixels) for displaying a thumbnail image are recorded. In the file attribute AT, read only attribute (R), archive attribute (A), system file attribute (S) and hidden file attribute (H) can be set. In the case where protection of a file is set by the user, the read only attribute is set. In the tag TG, information of file name, date and time of image capturing, serial number of a digital camera used for the image capturing, and sound file associated with image data is recorded.

In the memory card 90, encrypted print unit price information is stored as a table TB in which the relation between the number of prints and unit price is described. In the print unit price table TB, print unit price is specified for each of print kinds. With reference to the print unit price table TB of FIG. 4, for example, when the print size is L and the number of prints is 9 or less, the print unit price is set as 40 yen. When the print size is 2 L and the number of prints is 50 or more, the print unit price is set as 50 yen. In such a manner, print charge which will be described later is displayed on the LCD 5. The print unit price information stored in the memory card 90 may be preliminarily stored in the memory card 90. Alternatively, print unit price information may be generated in the digital camera by operating the operation part 30 by the user and stored into the memory card 90. The print unit information may be stored not necessarily in the memory card 90 but may be also stored in a storing unit such as the RAM 50a.

When the image capturing mode is switched to the playback mode by depression of the mode switching button 11, data of an image of the largest frame number in the memory card 90, that is, an image captured most recently is read and decompressed by the compressor/decompressor 52, and the resultant image is displayed on the LCD 5. In the playback mode, the frame advance and frame reverse can be performed by depression of the left button 7c and the right button 7d, respectively.

A card interface (I/F) 60 is an interface for writing/reading image data to/from the memory card 90 inserted in the insertion part in the side face of the digital camera 1. Also when data writing or reading operation is not performed, the overall controller 50 performs a process of periodically accessing the memory card 90 via the card interface 60 and periodically monitors insertion of the memory card 90 to the card interface 60.

At the time when the overall controller 50 reads/writes image data from/to the memory card 90, the process of compressing/decompressing image data is performed in, for example, the JPEG system by the compressor/decompressor 52 and image data is transmitted/received between the buffer memory 54 and the memory card 90 via the card interface 60. Also at the time of reading/writing sound data, sound data is transmitted/received between the buffer memory 54 and the memory card 90 via the card interface 60.

Further, by using the card interface 60, the digital camera 1 can perform not only transmission/reception of data such as an image and sound but also reception of a program which operates on the digital camera 1. For example, a control program recorded on the memory card 90 can be stored into the RAM 50a or ROM 50b in the overall controller 50. Consequently, the control program can be updated.

Also by communication with an external apparatus (such as an external computer) via the USB terminal 16, various data such as an image and sound, a control program or the like can be transmitted/received. For example, various data, a program or the like recorded on a recording medium (such as CD-R/RW or CD-ROM) set in a reading device (such as an optical drive device) of an external computer can be obtained via the USB terminal 16.

Print Mode

When the print button 13 is depressed by the user, the digital camera 1 enters the print mode for performing print settings, and a print setting screen is displayed on the LCD 5. Specifically, by an operation input to the print button, a print setting mode for making a print order setting independent of the image capturing mode and the playback mode is set.

In the print mode, a print order file regarding print settings is created. The print order file will be described first.

FIG. 5 is a diagram for describing a print order file Pf.

In the memory card 90, a plurality of image files Gf are stored in a captured image folder Fa and the print order file Pf is stored in a folder Fb different from the captured image folder Fa.

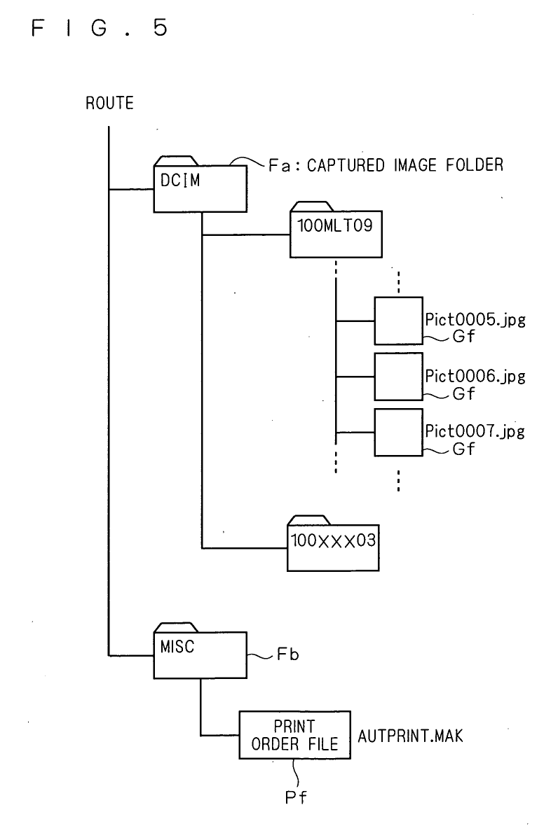

The print order file Pf is constructed by, as shown in FIG. 6, general information Df1, user information Df2, print job information Df3, image source information Df4, various settings information Df5 and vendor information Df6. The vendor information Df6 is information which is defined by each of manufactures of digital cameras.

By creating the print order file Pf, labor of the user at the time of print order can be reduced. The print setting screen for setting the various information Df1 to Df6 in the print order file Pf will now be described.

FIG. 7 is a diagram for describing the print setting screen.

In a print setting screen Gp displayed on the LCD 5, a captured image Gq to be subjected to print settings which is read from the memory card 90 is displayed. Total number indication Gp1 indicative of the total number of images ordered to be printed (the total number of prints) and order number indication Gp2 of the number of prints ordered of the image presently displayed on the LCD 5, which is shown in an upper right portion (specific portion) in the LCD 5 are displayed so as to be superimposed on the image Gq to be printed. In short, a captured image to be subjected to print settings, information of the print settings on the captured image, and the total number of prints based on all of the print settings recorded in the print order file Pf are displayed on the LCD 5.

On the other hand, when the digital camera 1 shifted to the print mode in response to depression of the print button 13, the electronic flash mode button 8c functions as a hold button, and the liquid crystal monitor button 8b functions as an erase button. In the print setting screen Gp, “hold” display Gp3 and “erase” display Gp4 for indicating that the functions are assigned are performed.

In the digital camera 1, in order to give priority to a print image, the image Gq is displayed in accordance with the aspect ratio of the print size. When the aspect ratio of the screen size of the LCD 5 and that of the print size are different from each other, for example, the size is adjusted by providing margins Gpe (parallel hatched parts) in both ends of the screen of the LCD 5. In the case of superimpose the date of image capturing on the image Gq, date display Gp5 such as “'03/5/7” is made in a superimpose portion of the image.

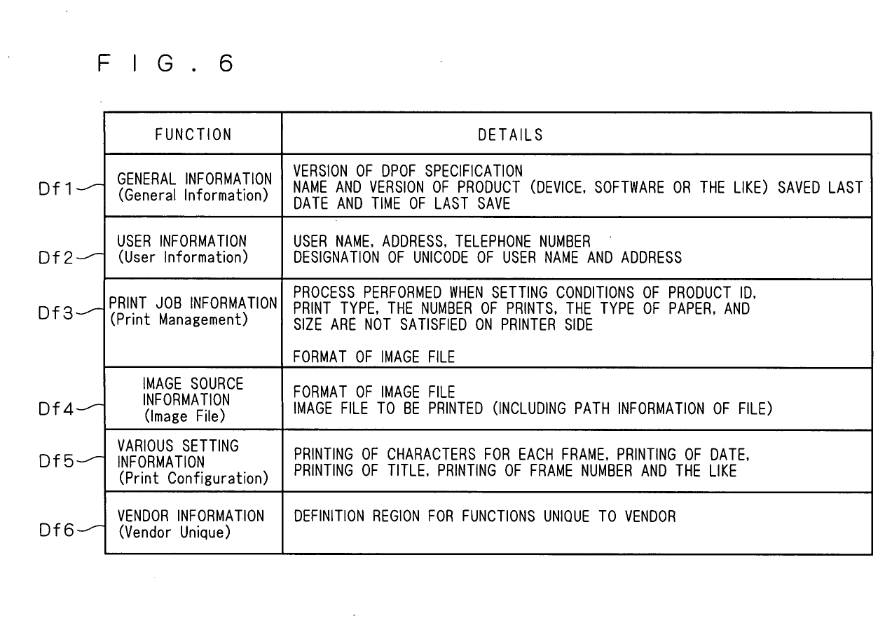

In the print setting screen Gp shown in FIG. 7, when the right button 7d or print button 13 is depressed, the subsequent image (frame) Gr is displayed as shown in FIG. 8 (to be described in detail later).

The operations in the print mode will now be described.

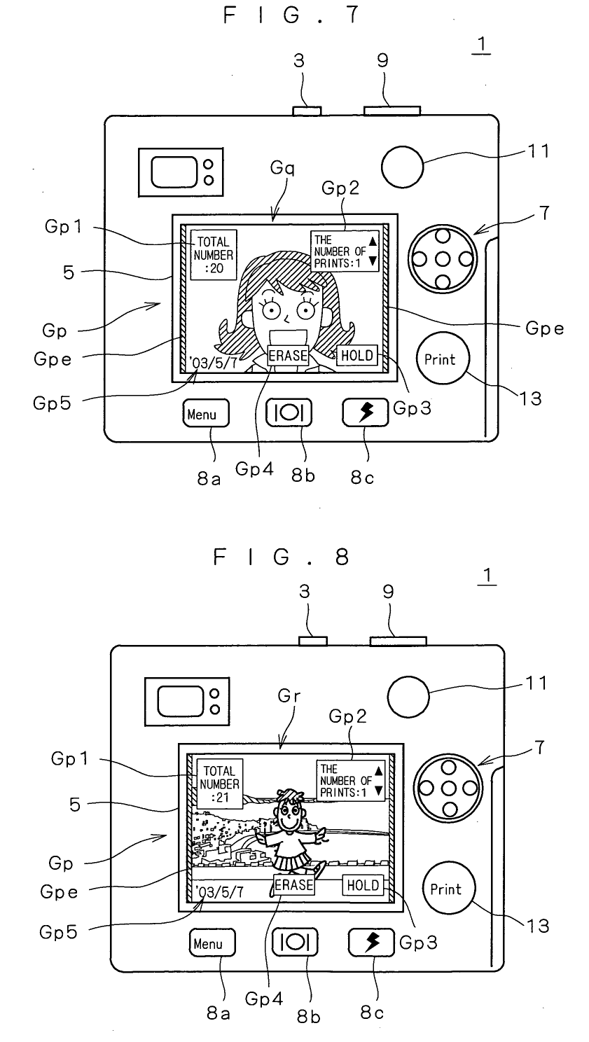

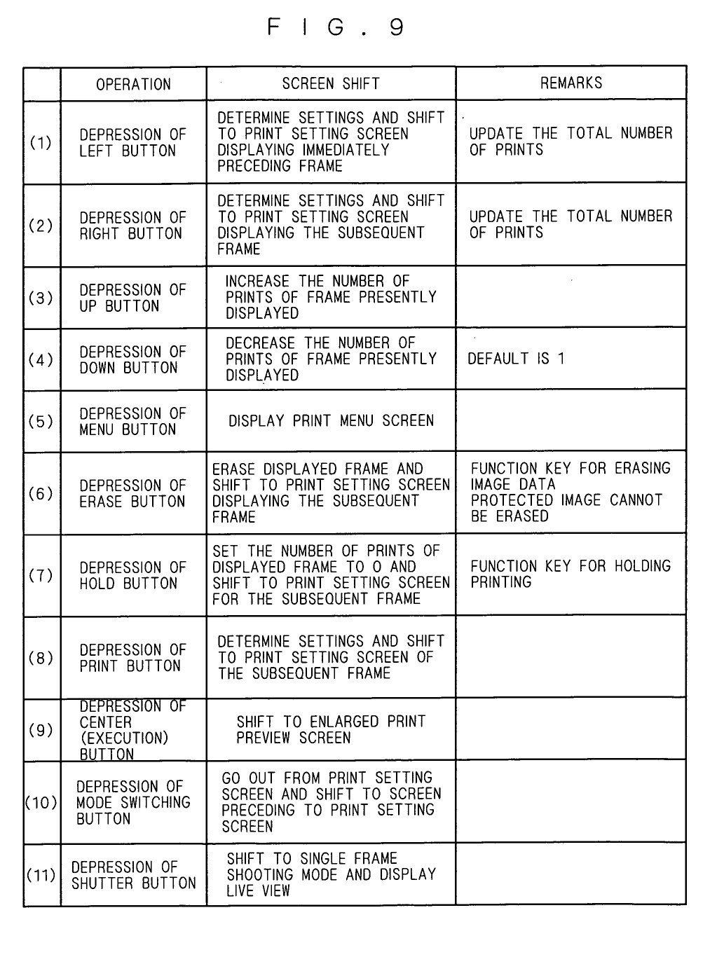

FIGS. 9 to 11 are diagrams for describing operations in the print mode for displaying the print setting screen Gp (FIG. 7) on the LCD 5. FIG. 9 shows the relation between the operation of the user and the screen transition and each of FIGS. 10 and 11 shows a state of transition from a print setting screen GN11 displaying an image of the frame number (n) to another screen. In the following description, the image of the frame number (n) will be regarded as an image having the latest (largest) frame number immediately after shift to the print mode. In FIG. 11, blocks having reference symbols starting with GN indicate states of the display screen, and blocks having reference symbols starting with ST show operations of the digital camera 1.

In the following, the operations of the print mode will be described with reference to FIGS. 10 and 11 for each of items (1) to (11) shown in FIG. 9.

(1) When the left button 7c is depressed, the settings made in the print setting screen are determined and the program shifts to the print setting screen displaying the immediately preceding frame. In this case, the print order number selected in the image before depression of the left button 7c is added to the print total number, and the total number is updated.

Specifically, in the case where the left button 7c is depressed in the print setting screen GN11 displaying an image of the frame number (n) shown in FIG. 11, a process ST12 of recording the print order of the image of the frame number (n) is performed, and the program shifts to a print setting screen GN12 of the image of the frame number (n-1).

Concretely, for example, when the left button 7c is depressed in the state where the print setting screen Gp is displayed as shown in FIG. 8, as shown in FIG. 12, the image Gq corresponding to the immediately preceding frame is displayed on the LCD 5 and, in the total number display Gp1, the total number “22” obtained by increasing “21” in the total number display Gp1 of FIG. 8 by one is displayed.

As described above, in the digital camera 1, depression of the left button 7c is one of the print setting operations for making print settings on the image displayed on the LCD 5. In the digital camera 1, when print settings are made on one captured image recorded on the memory card 90 by performing an operation for the operation part 30, in response to it, the print order file Pf (see FIG. 5) recorded on the memory card 90 is updated. In the case where the print order file Pf does not exist on the memory card 90 when the print setting operation is performed, the print order file Pf is created at that time point.

In the case of displaying the total number in the total number indication Gp1, the overall controller 50 reads the print order file Pf from the memory card 90 and performs an arithmetic operation on the basis of the print setting state of each of images included in the file, thereby updating the total number indication Gp1.

(2) When the right button 7d is depressed, settings in the print setting screen are determined and the program shifts to the print setting screen displaying the subsequent frame. In this case, the print order number selected in the image before depression of the right button 7d is added to the print total number, and the total number is updated.

Specifically, when the right button 7d is depressed in the print setting screen GN12 displaying the image of the frame number (n-1) shown in FIG. 11, a process ST 13 of recording the print order of the image of the frame number (n-1) of the print order file Pf is performed, and the program shifts to he print setting screen GN11 of the image of the frame number (n).

Concretely, for example, when the right button 7d is depressed in the state where the print setting screen Gp is displayed as shown in FIG. 7, as shown in FIG. 8, an image Gr corresponding to the subsequent frame is displayed on the LCD 5, and the total number “21” obtained by increasing “20” shown in the total number display Gp1 of FIG. 7 by one is displayed in the total number display Gp1.

Consequently, depression of the right button 7d is also one of the print setting operations for making print settings on the image displayed on the LCD 5 in the digital camera 1. Therefore, at the time when the right button 7d is depressed and the settings in the print setting screen are determined, the print order file Pf recorded on the memory card 90 is updated.

(3) When the up button 7a is depressed, as shown in FIG. 10, the number of prints of the frame (image) which is currently displayed on the LCD 5 is increased. Therefore, the number in the print number display Gp2 increases.

(4) When the down button 7b is depressed, as shown in FIG. 10, the number of prints of the frame (image) which is currently displayed on the LCD 5 is decreased. Therefore, the number in the print number display Gp2 decreases. The default value of the number of prints is set as 1 and the lower limit value of the print number is 0.

(5) When the menu button 8a is depressed, as shown in FIG. 10, the print menu screen (which will be described later) is displayed on the LCD 5.

(6) When the erase button 8b is depressed, the frame (image) which is currently displayed on the LCD 5 is erased, and the program shifts to the print setting screen displaying the subsequent frame. The erase button 8b functions as a function key for erasing captured image data. However, even when the erase button 8b is depressed, a protected image, concretely, an image which is set in the read only attribute R in the file attribute shown in FIG. 4 cannot be erased.

For example, when the erase button 8b is depressed in the print setting screen GN12 displaying the image of the frame number (n-1) shown in FIG. 11, a process ST 14 of erasing the image of the frame number (n-1) is performed, and the program shifts to the print setting screen GN11 displaying the image of the frame number (n).

When the erase button 8b is depressed in the print setting screen GN11 displaying the image of the maximum frame number (n) shown in FIG. 11, a process ST 1I for erasing the image of the frame number (n) is performed and, after that, the program shifts to the print setting screen GN12 displaying an image of the maximum frame number (n-1) after the erasing process.

(7) When the hold button 8c is depressed, the number of prints of the frame (image) currently displayed on the LCD 5 is set to 0, and the program shifts to the print setting screen displaying the subsequent frame.

Specifically, when the hold button 8c is depressed in the print screen GN12 displaying the image of the frame number (n-1) shown in FIG. 11, the print order contents regarding the image of the frame number (n-1) in the print order file Pf are checked. When the print order number is 1 or more, a process ST17 for erasing the print order contents regarding the image of the frame number (n-1), that is, for setting the number of prints to 0 is performed. The program shifts to the print setting screen GN11 displaying the image of the frame number (n).

In the case where the hold button 8c is depressed in the print setting screen GN11 displaying the image of the frame number (n) shown in FIG. 11, the order contents regarding the image of the frame number (n) in the print order file Pf are checked. When the print order number is 1 or more, a step ST16 for erasing the order contents regarding the image of the frame number (n), that is, setting the number of prints to 0 is performed. Since the frame number (n) is the largest and the subsequent frame does not exist, the program returns to the print setting screen GN11 displaying the image of the frame number (n).

(8) When the print button 13 is depressed, the settings made in the print setting screen are determined, and the program shifts to the print setting screen displaying the next frame.

Specifically, when the print button 13 is depressed in the print setting screen GN12 displaying the image of the frame number (n-1) shown in FIG. 11, the ordering process ST13 of the image of the frame number (n-1) is performed, and the program shifts to the print setting screen GN11 displaying the image of the frame number (n).

Concretely, for example, when the print button 13 is depressed in the state where the print setting screen Gp of FIG. 7 is displayed, as shown in FIG. 8, the image Gr corresponding to the subsequent frame is displayed on the LCD 5 and, also, the print order file Pf is updated. The total number “21” obtained by increasing “20” in the total number display Gp1 of FIG. 7 by one is displayed in the total number display Gp1.

In the case where the print button 13 is depressed in the print setting screen GN11 displaying the image of the frame number (n) shown in FIG. 11, an ordering process ST15 on the image of the frame number (n) is executed. In this case, the frame number (n) is the largest and the next frame does not exist, so that the program returns to the print setting screen GN11 displaying the image of the frame number (n).

As described above, depression of the print button 13 is also one of the print setting operations for making the print settings on an image displayed on the LCD 5 in the digital camera 1.

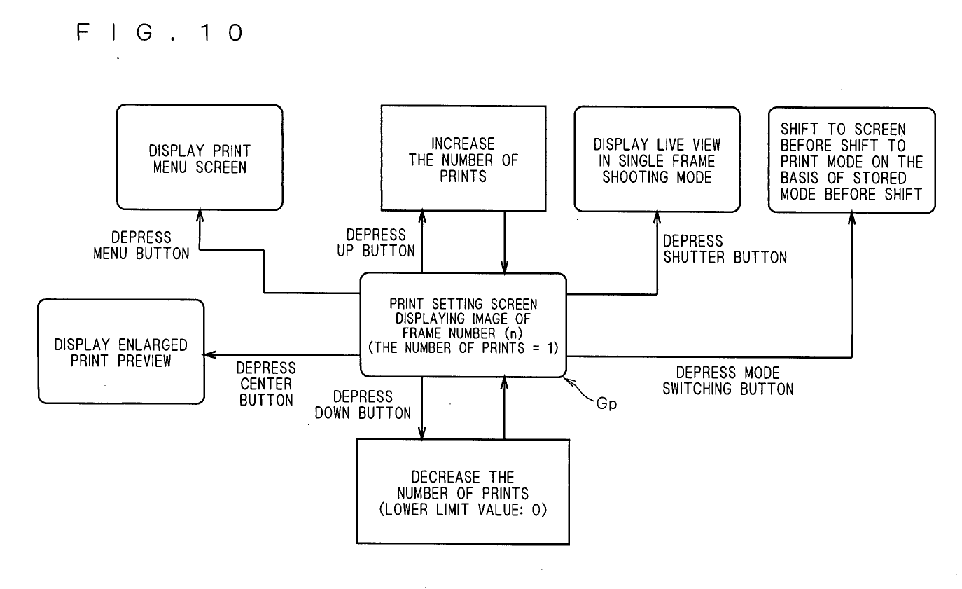

(9) When the center (execution) button 7e is depressed, the program shifts to an enlarged print preview screen Gpw (see FIG. 13) as shown in FIG. 10. In the enlarged print preview screen Gpw, an image Gqw of which display magnification is, for example, twice as large as the print setting screen Gp (see FIG. 7) in which the image Gq of which display magnification is one is displayed while the print setting information such as the total number display Gp1 and the order number display Gp2 remains the same without being enlarged. The user can visually recognize the details of the image of the enlarged print preview screen Gpw.

(10) When the mode switching button 11 is depressed, the program goes out from the print setting screen as shown in FIG. 10 and shifts to the screen (such as the menu screen of the image capturing mode) before the shift to the print setting screen on the basis of information of the shift source mode stored in the RAM 50a.

(11) When the shutter button 9 is depressed, as shown in FIG. 10, the program shifts to the single frame shooting mode and the live view display is made.

The order recording operation in steps ST12, ST13 and ST15 in FIG. 11 will be described below.

FIG. 14 is a flowchart showing the print order recording operation on an image of the frame number (n).

First, when the print button 13 or the like is depressed, it is determined whether the print order file exists in the memory card 90 or not (step SP1). In the case where a print order file exists, the program advances to step SP2. In the case where the print order file does not exist, the program advances to step SP4.

In step SP2, it is determined whether the order contents have been changed or not. For example, it is determined whether the number of prints has increased or not by depression of the up button 7a or down button 7b. If the order contents have been changed, the program advances to step SP3. If the order contents have not been changed, the program goes out from the flowchart and finishes the print order recording process.

In step SP3, the print order file is updated with the changed order contents of the image of the frame number (n) to be print ordered.

In step SP4, a print order file is newly created. Consequently, when the print button 13 is depressed and the program shifts to the print mode, a print order file is created in the memory card 90.

In step SP5, the order contents of the image of the frame number (n) to be print ordered are recorded in the print order file.

In step SP6, the total number of prints is updated. Consequently, the number of total prints or the like in the total number indication Gp1 in the print setting screen, which is displayed on the basis of the print order file, is changed.

When the print settings are made on the captured image being displayed on the LCD 5 by the operation of the print order recording, the contents of the print settings are recorded on the memory card 90.

In the digital camera 1, by depressing the left button 7c or the right button 7d, at least one print of a desired image can be ordered. Thus, an order omission can be prevented and the convenience of the user improves.

In the digital camera 1, in the print setting screen in the print mode, the operation for changing a display image on which print settings are to be made to another image and the operation for determining print settings are the print setting operations for determining print settings on the display image. The digital camera 1 is constructed so as to update the print order file Pf recorded on the memory card 90 each time such a print setting operation is performed. Consequently, even if the user takes out the memory card 90 from the digital camera 1 during the print mode after the print settings for a plurality of images are made, the print order file Pf on which the print setting information for the plurality of images is excellently recorded is stored in the memory card 90. In addition, even if the power source battery BT is exhausted during the print setting operation, the print settings made by the print setting operation by the time are recorded excellently on the memory card 90 as the print order file.

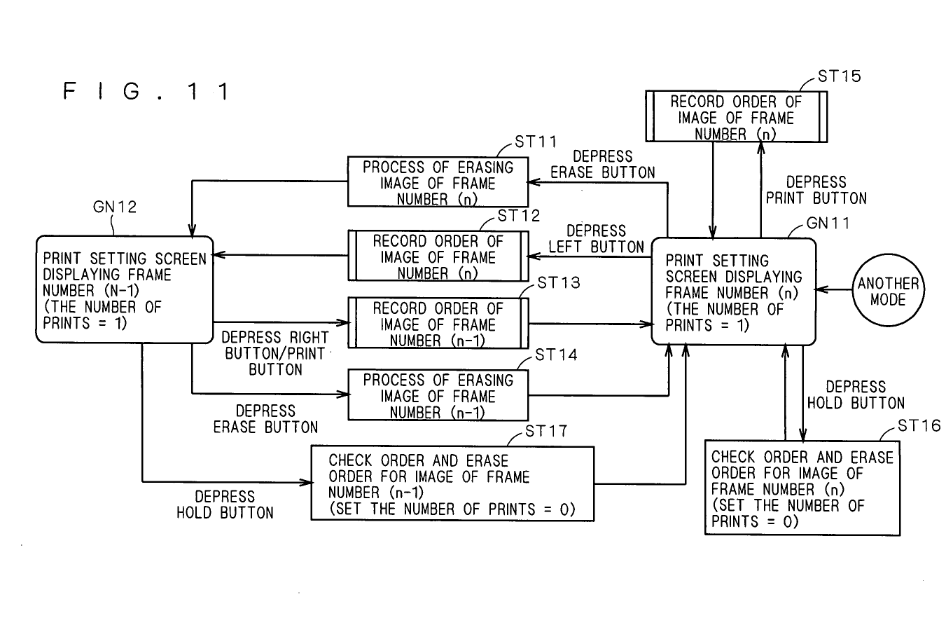

When the menu button 8a is depressed in the print setting screen, the program shifts to the print menu screen Gpm shown in FIG. 15. The print menu screen Gpm will now be described.

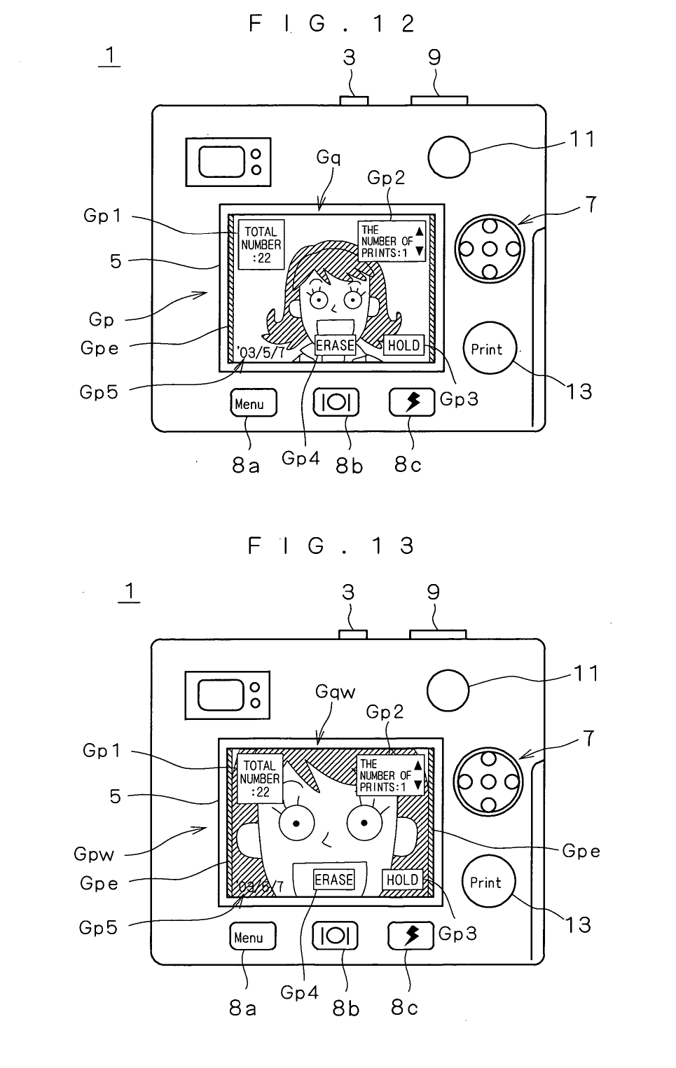

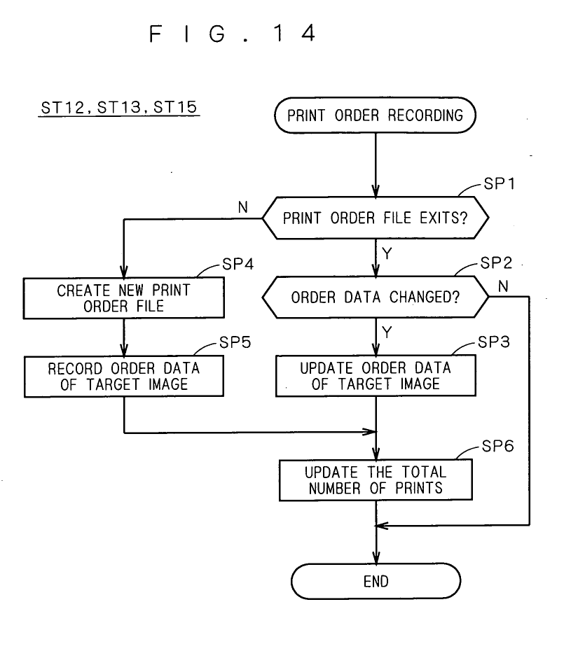

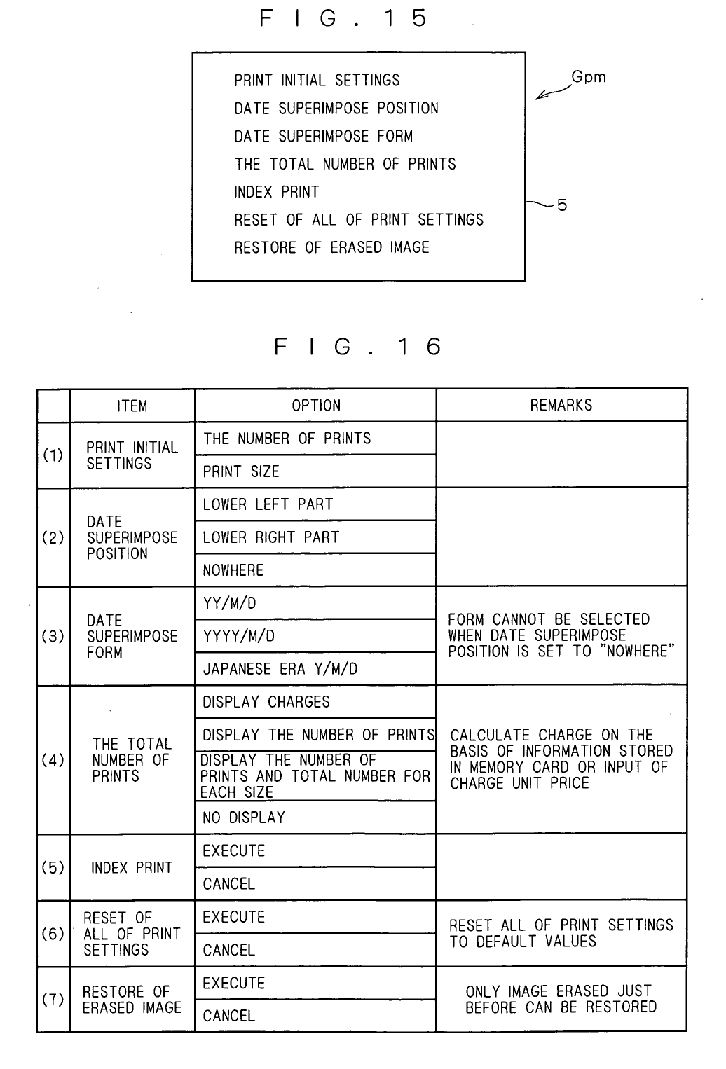

FIG. 16 is a diagram for describing the items displayed in the print menu screen Gpm. In the following, the functions of the print menu screen will be described for each of the items (1) to (7) shown in FIG. 16. FIGS. 17A to 17D are diagrams each showing a print setting screen of a different display mode.

(1) When the print initial setting is designated, the default number of prints or default print size can be selected with respect to print designation by using the button group 7. In the digital camera 1, the default print setting conditions can be changed.

(2) When a date superimpose position is designated, with respect to the date superimpose position on a print image corresponding to the date display Gp5 (FIG. 7), “lower left” in an image (screen), “lower right” in an image, or “none” for inhibiting date superimpose can be selected.

(3) After the date superimpose form is designated, the form of “YY/M/D”, “YYYY/M/D” or “Japanese Era Y/M/D” can be selected. In the case where the date superimpose position is set to “none”, the date superimpose form cannot be designated.

(4) When the total number of prints is designated, “display of charges”, “display of the number of prints”, “display of the number of prints for each size and the total number”, or “no display” can be selected. When “display of charge” is set here, as shown in FIG. 17A, total charge for the total number of prints is calculated and the indication Gp11 of charge is displayed on the LCD 5. When “display of the number of prints” is set, indication Gp12 of only the total number is displayed on the LCD 5 as shown in FIG. 17B. When “display of the number of prints for each size and the total number” is set, as shown in FIG. 17C, display Gp13 of the total number and the number of prints by size such as the number of prints of the L size, and the number of prints of the 2L size is displayed on the LCD 5. Further, when “no display” is set, as shown in FIG. 17D, the total number is not displayed on the LCD 5. In the case of displaying charge, for example, the charge may be calculated on the basis of either unit price information (the print unit price table TB in FIG. 4) prestored in the memory card 90 or, a unit price which is set and input by the user.

(5) When the index print is designated, either “yes” or “no” of index print can be selected.

(6) When reset of all of the print settings is designated, “execute” or “cancel” can be selected. In the case where “execute” is selected, the settings of all of the numbers of prints are reset to the default values which are set in the print initial settings.

(7) When restore of the erased image is designated, “execute” or “cancel” can be selected. Even in the case where “execute” is selected, to effectively utilize the capacity of the memory card, an image which can be restored is only the image erased just before.

As described above, settings can be made for each of the items shown in FIG. 16. As a concrete example, operations of making print initial settings and setting of the total number of prints will now be described.

FIG. 18 is a diagram for describing the operation of the print initial settings. In the diagram, blocks having reference symbols starting with GN indicate states of the display screen, and blocks having reference symbols starting with ST show processes of the digital camera 1.

When the menu button 8a is depressed in a state GN15 displaying the print setting screen, the program shifts to a state GN16 in which the print menu screen Gpm is displayed. When the “print initial setting” is selected in the state GN16 and the execution (center) button 7e is depressed, the digital camera 1 allows the program shift to a state GN17 in which the screen for making the print initial setting is displayed.

In the display state GN17, an initial setting of the number of prints and an initial setting of the print size can be made. For example, when the number of prints is set as two, in the print setting screen in which an image is displayed first, “2” is displayed in the order number display Gp2 (see FIG. 7 and the like). In such a manner, initial settings can be easily made, so that convenience of the user improves.

In the display state GN17, the number of prints can be changed by depressing the up button 7a or down button 7b, and the print size can be changed by depressing the right button 7d or left button 7c.

When the execution (center) button 7e or print button 13 is depressed in the display state GN17, the program shifts to the state GN15 showing the print setting screen in which the initial settings are reflected. On the other hand, when the hold button 7c is depressed, the program shifts to the state GN15 in which the print setting screen in which initial settings are not reflected is displayed.

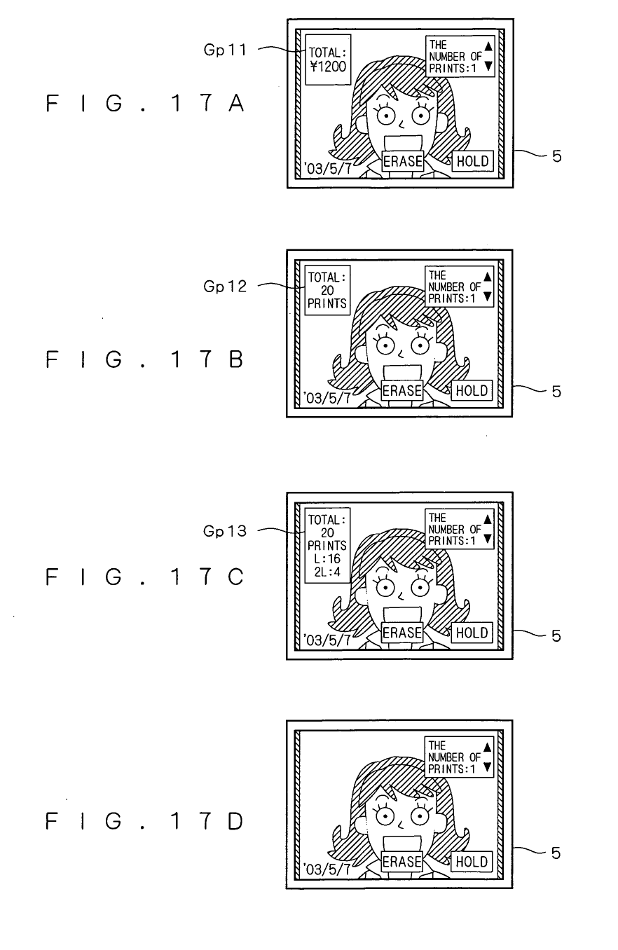

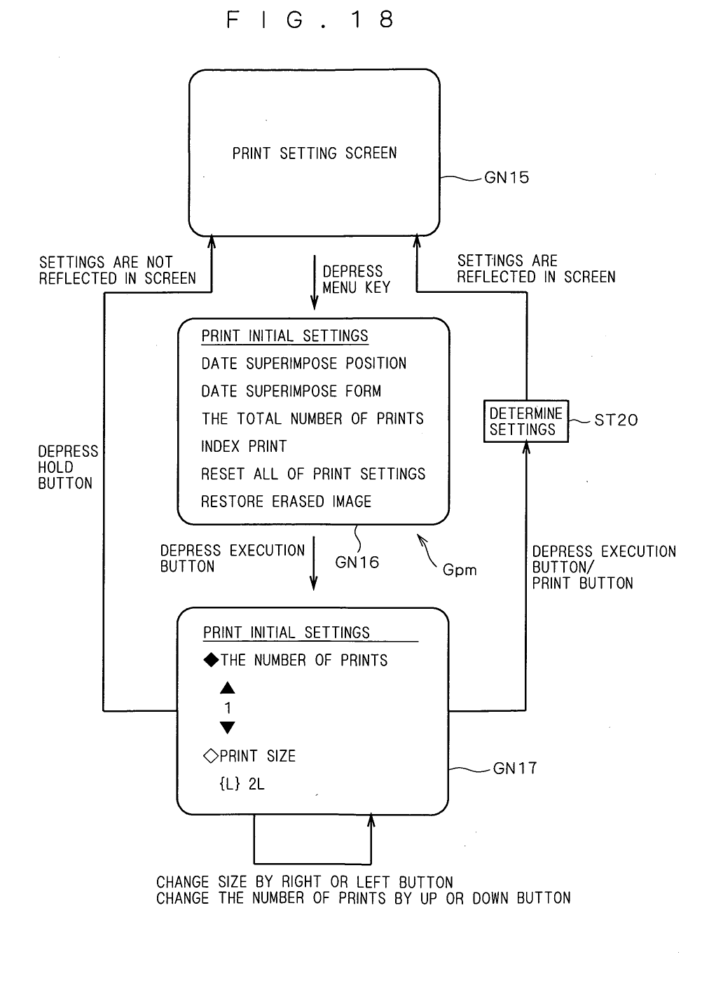

FIGS. 19 and 20 are diagrams for describing a print total number display setting operation. In the diagrams, blocks having reference symbols starting with GN indicate states of the display screen, and blocks having reference symbols starting with ST show processes of the digital camera 1.

In the case where the menu button 8a is depressed in a state GN20 in which the print menu screen Gpm (FIG. 15) is displayed, the program shifts to any of menu display states GN21 to GN24 corresponding to print setting screens (four kinds of screens shown in FIGS. 17A to 17D) immediately before a shift to the print menu screen Gpm. In the menu display states GN21 to GN24, the setting regarding each display mode such as the display of the total number of prints can be changed. The setting can be changed by depressing the right and left buttons 7d and 7c.

When the execution (center) button 7e is depressed in the state GN21 in which an amount display setting is selected, the program shifts to the state GN25, shown in FIG. 20, in which a screen for selecting “reading from memory card” for a unit price setting is displayed. When the execution (center) button 7e is depressed, a process ST21 of reading the unit price information registered in the memory card 90 (registered information), that is, the print unit price table TB shown in FIG. 4 is performed, and a process ST22 of determining whether registered information exists in the memory card 90 or not is performed. In the case where registered information exists in the process ST22, the program shifts to a state GN27 in which charge setting data is displayed on the basis of the information and, by depression of the execution (center) button 7e, a process ST23 of updating the displayed data is executed. On the other hand, when registered information does not exist in the process ST22, the program shifts to a state GN28 in which a warning of “no charge information in the memory card” is displayed. When the execution (center) button 7e is depressed in this state GN28, the program shifts to a state GN26.

On the other hand, when the down button 7b is depressed in a state GN25, the program shifts to the state GN26 in which a screen for selecting “manual setting” for unit price setting is displayed. In this case, the amount per one print can be increased/decreased by operating the left and right buttons 7c and 7d. When the up button 7a is depressed, the program shifts to the state GN25. Alternatively, in the state GN26, the unit price for each print kind such as print size may be inputted.

General Operation of Digital Camera 1

Then, the general operation of the digital camera 1 such as the relation between the print mode and the other modes (image capturing mode and playback mode) will be described below.

FIG. 21 is a state transition diagram showing basic operation of the digital camera 1.

First, when the power source button 3 is depressed in a state where the power source of the digital camera 1 is off, the program shifts to a state ST31 of checking a mode at the time of turn-on stored in the ROM 50b. At the time of shipment of the digital camera 1, the image capturing mode is set.

The program shifts to a state ST32 in which the mode determined in state ST31 is set. As the modes of the digital camera 1, there are the print mode, image capturing modes (single frame shooting mode, motion picture mode and continuous shooting mode) and playback mode. By depression of the mode switching button 11 and the print button 13, the mode can be switched among the five kinds of modes. In the case where the menu button 8a is depressed in the state ST32, the program shifts to a state ST33 in which a screen for setting various menus according to the mode is displayed on the LCD 5.

On the other hand, when the power source button 3 is depressed in the state ST32, via a state ST34 for storing the currently set mode into the ROM 50b, the power source of the digital camera 1 is turned off.

The relation between the print mode as one of the five modes and the other four kinds of modes will be described with reference to FIG. 22 showing a state transition.

In states GN81 to GN84 in which the single frame shooting mode, continuous shooting mode, motion picture mode and playback mode are set, respectively, the mode is cyclically switched by depression of the mode switching button 11. At the time of shifting the state GN83 in which the motion picture mode is set to the state GN84 in which the playback mode is set, a captured image of the largest frame number is displayed on the LCD 5.

When the print button 13 is depressed in the states GN81 to GN83 in which the single frame shooting mode, continuous shooting mode and motion picture mode are set, respectively, via an error check ST41 which will be described in detail later, the program shifts to a state GN85 in which the print mode is set. Immediately after the shift to the state GN85, a captured image of the largest frame number is displayed on the LCD 5 among the captured images recorded on the memory card 90.

When the print button 13 is depressed in the state GN84 in which the playback mode is set, the program shifts to the state GN85 in which the print mode is set. Immediately after the shift to the state GN85, the same image as an image played back on the LCD 5 in the state GN84 is displayed. Even when the shutter button 9 is depressed in the state GN84, the program shifts to the state GN81 in which the single frame shooting mode is set.

Also when the print button 13 is depressed in the state GN85 in which the print mode is set, a process of updating the print order contents or the like is performed as described above, but the setting of the print mode is maintained. In the case where the shutter button 9 is depressed in the state GN85, the program shifts to the state GN81 in which the single frame shooting mode is set.

FIG. 23 is a flowchart showing the operation of an error check corresponding to the state ST41.

First, it is determined whether a captured image is stored in the memory card 90 or not (step ST51). In the case where a captured image is stored, the program advances to step ST52. In the case where a captured image is not stored, the program advances to step ST53.

In step ST52, a captured image of the largest frame number is designated and an image file (data) is read. After completion of the reading, the program shifts to the state GN85 (FIG. 22) in which the print mode is set. Even when the print button 13 is depressed in step ST52, the print button 13 is ignored and the reading of a file is continued. This operation prevents the file from being destroyed.

In step ST53, the mode (single frame shooting mode, continuous shooting mode or motion picture mode) which is set before the shift to the error check ST45 is stored.

In step ST54, a warning that “there is no image in memory card” is displayed on the LCD 5. After lapse of about two seconds or in response to the depression of the execution (center) button 7e, print button 13 or mode switching button 11, the program returns to the mode before the shift stored in the step ST53.

By the error check operation, the digital camera I can be prevented from shifting to the print mode in the case where there is no captured image in the memory card 90.

Card Replacing Operation in Print Mode

Operations of the digital camera 1 performed at the time of replacing the memory card 90 in the print mode will now be described.

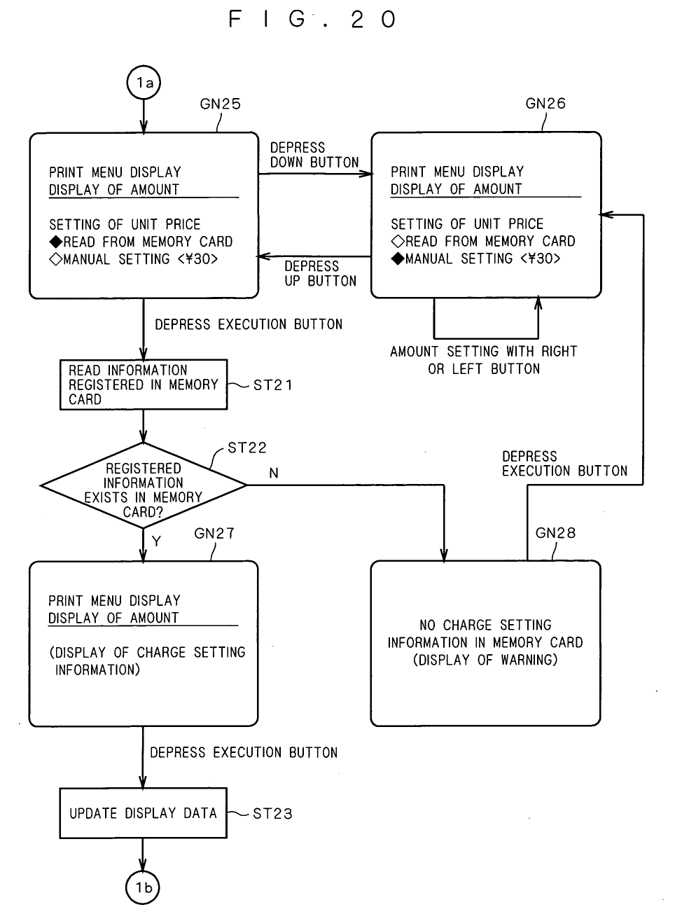

FIGS. 24 and 25 are diagrams for describing operations of the digital camera 1 in the case where an operation of replacing the memory card 90 is performed by the user when a print setting screen is displayed on the LCD 5 in the print mode. Also in the diagrams, blocks having reference symbols starting with GN indicate states of the display screen, and blocks having reference symbols starting with ST indicate processes of the digital camera 1.

A print setting screen display state GN61 in FIG. 24 is a state where any of the four kinds of print setting screens shown in FIGS. 17A to 17D is displayed and the user performs the print setting operation in the print mode. When the user performs an operation of taking out the memory card 90 from the digital camera 1 in the state GN61, the digital camera 1 stores the display mode just before the operation, to be specific, the display mode in which one of the four kinds of print setting screens (FIGS. 17A to 17D) is displayed into the RAM 50a (step ST61).

After that, the digital camera 1 invalidates the function of the hold button assigned to the electronic flash mode button 8c and the function of the erase button assigned to the liquid crystal monitor button 8b in the print mode (step ST62). By the operation, even when the electronic flash mode button 8c or the liquid crystal monitor button 8b is operated in a state where the memory card 90 is not inserted in the digital camera 1, internal processes corresponding to the button operations are not executed in the digital camera 1.

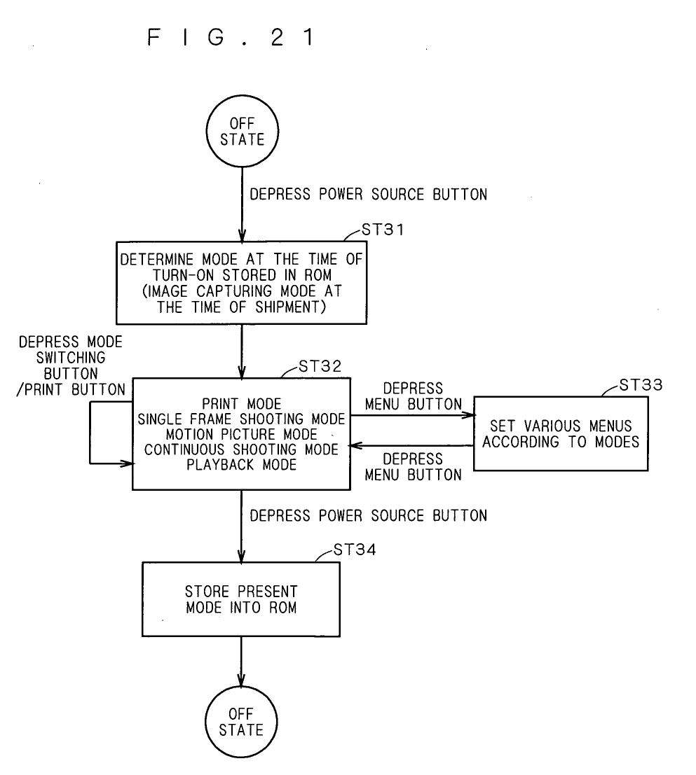

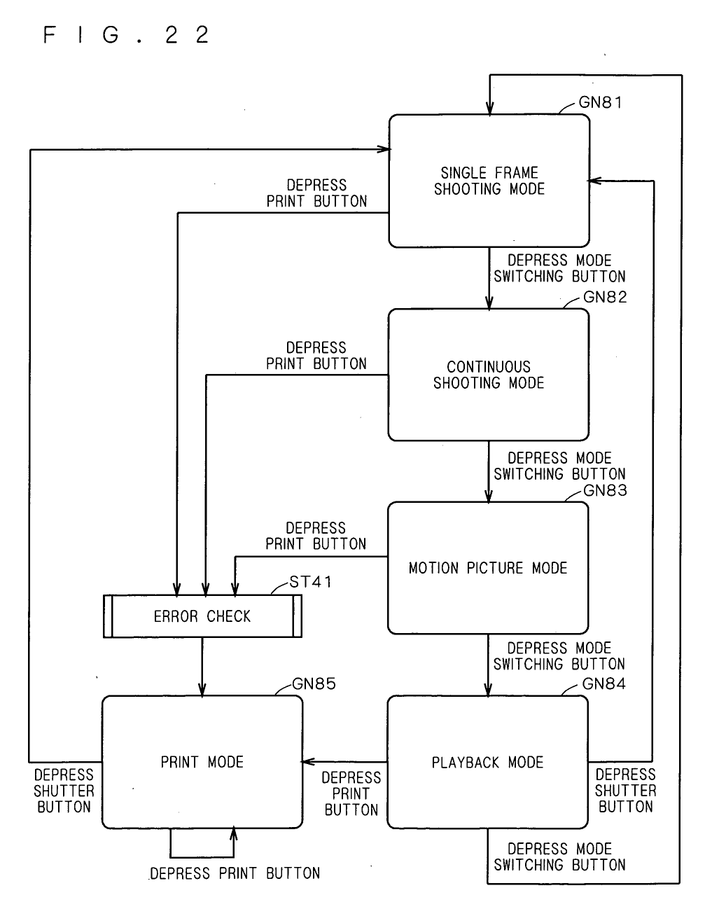

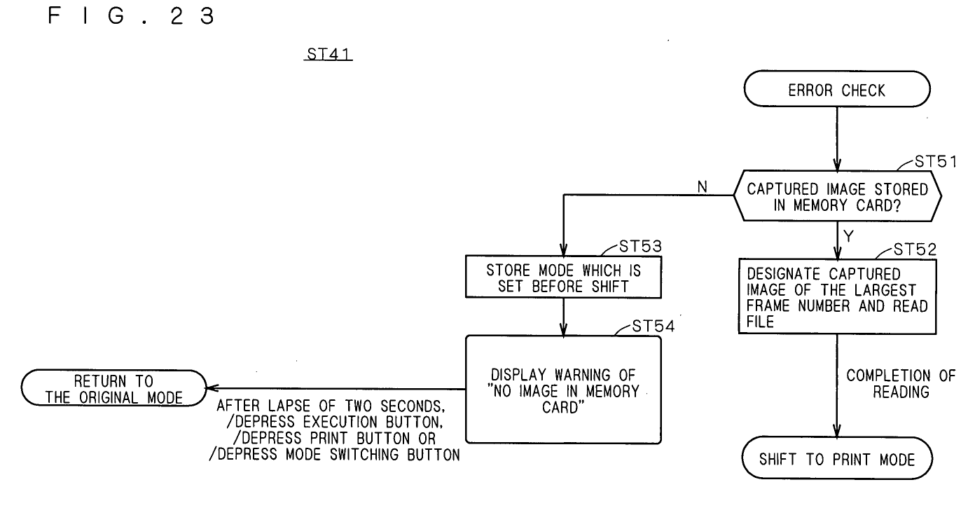

The digital camera 1 shifts to a state GN62 in which a card uninsertion warning screen is displayed on the LCD 5. In the state GN62, according to the immediately preceding display mode, any one of the four kinds of warning displays shown in FIGS. 26A to 26D is displayed.

Concretely, in the case where the indication Gp11 (FIG. 17A) of total charge to make the total number of prints is displayed on the print setting screen immediately before the memory card 90 is taken out, also in the state GN62 after the card is taken out, the warning screen (FIG. 26A) displaying the indication Gp11 is displayed. In the warning screen (FIG. 26A), however, indication of the total charge and indication of the set number displayed immediately before taking out of the card is made invalid. In the indication boxes, for example, a sign such as “-” is displayed.

In the case where the indication Gp12 (FIG. 17B) of the total number corresponding to the total number of prints is displayed on the print setting screen immediately before the memory card 90 is taken out, the warning screen (FIG. 26B) displaying the indication Gp12 is displayed also in the state GN62. Also in the warning display (FIG. 26B), the total number and the like displayed immediately before the card is taken out are shown invalid.

In the case where the indication Gp13 (FIG. 17C) for displaying the total number corresponding to the total number of prints and the number of prints by size such as L size and 2L size is displayed on the print setting screen immediately before the memory card 90 is taken out, the warning screen (FIG. 26C) on which the indication Gp13 is displayed in the state GN62. Also in the warning display (FIG. 26C), the total number and the like displayed immediately before the card is taken out are shown invalid.

Further, in the case where the print setting screen displayed immediately before the memory card 90 is taken out is a screen which does not show the total number of prints, total charge, and the like, also in the state GN62, the warning screen (FIG. 26D) which does not show the indications Gp11 to Gp13 and the like is displayed. In a manner similar to the above, the number of prints shown immediately before the card is taken out is invalid in the warning display (FIG. 26D).

As described above, in the state GN62 where the warning screen is displayed on the LCD 5, the warning is displayed in a display mode in which the display state immediately before the card is taken out is continued. More concretely, since the memory card 90 is not inserted, a captured image to be subjected to print setting is not displayed on the print setting screen but only indication boxes for print settings are displayed. A warning is displayed in such a manner that words of a warning or the like are filled in a region in which a captured image is supposed to be displayed.

The user inserts the memory card 90 into the digital camera 1 in the state GN62 where any of the warning screens (FIGS. 26A to 26D) is displayed. The memory card 90 to be inserted may be different from the memory card which has been taken out or the same as the memory card which has been taken out.

When insertion of the memory card is detected in the digital camera 1, the overall controller 50 accesses the inserted memory card 90 and determines whether a captured image is recorded or not (step ST63). In the case where no captured image is recorded on the memory card 90 (“NO” in step ST63), print settings cannot be made for the memory card 90, so that the digital camera 1 shifts to a state GN63 where the warning screen indicating that no image is recorded is displayed.

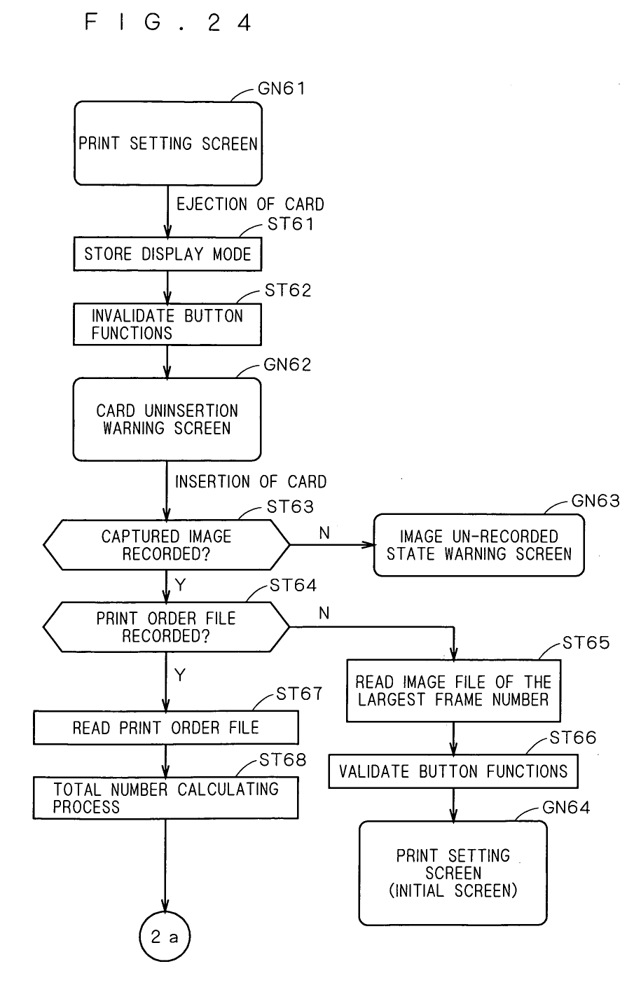

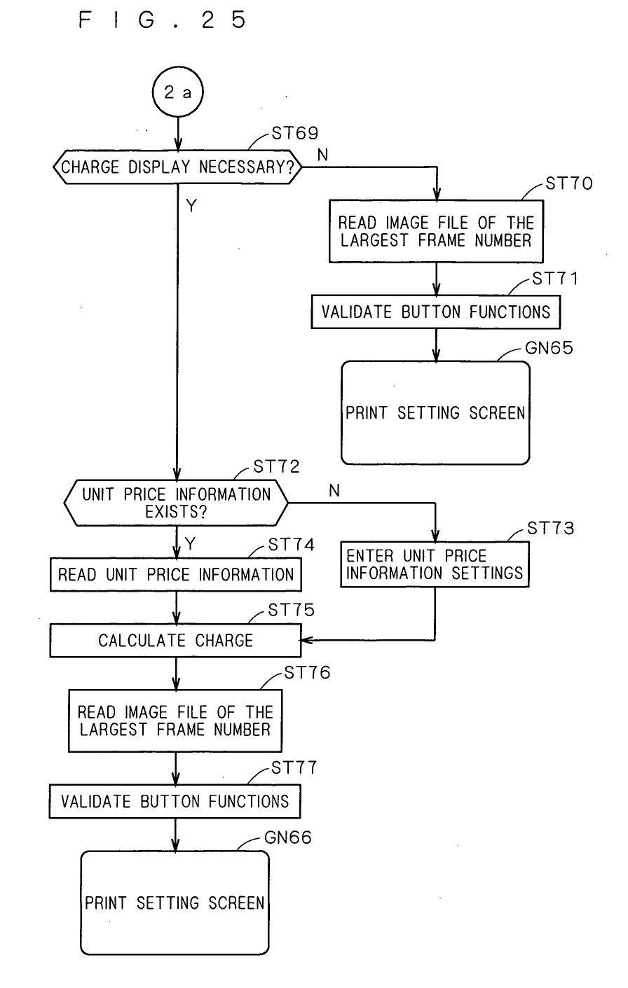

FIGS. 27A to 27D are diagrams showing examples of the screen displayed on the LCD 5 in the state GN63. In the state GN63, according to the display mode immediately before the memory card is taken out, any of the four kinds of warnings shown in FIGS. 27A to 27D is displayed.

The display screen of FIG. 27A is a screen displayed in the case where the indication Gp11 (FIG. 17A) of total charge required for the total number of prints is displayed in the print setting screen immediately before the memory card 90 is taken out. The display screen of FIG. 27B is a screen displayed in the case where the indication Gp12 (FIG. 17B) of the total number corresponding to the total number of prints is displayed in the print setting screen immediately before the memory card 90 is taken out. The display screen of FIG. 27C is a screen displayed in the case where the indication Gp13 (FIG. 17C) of the total number corresponding to the total number of prints and the number of prints by size such as L size and 2L size is displayed in the print setting screen immediately before the memory card 90 is taken out. Further, the display screen of FIG. 27D is a screen displayed in the case where the total number, total charge and the like are not shown in the print setting screen immediately before the memory card 90 is taken out. That is, also in the warning state showing that no image is recorded in the state GN63, in a manner similar to the state GN62, a warning is displayed in the display mode in which the display state immediately before the card is taken out is continued. Also in this case, no captured image is recorded on the memory card 90. Consequently, a captured image to be subjected to print settings is not displayed but only the indication boxes for print settings are displayed on the print setting screen. A warning is displayed in such a manner that words of a warning or the like are filled in a region in which a captured image is supposed to be displayed.

By the warning screen display in the warning state GN63, the user can grasp that the print setting operation cannot be performed on the newly inserted memory card 90. By performing a memory card replacing operation, a print mode finishing operation or the like, the warning state GN63 can be finished.

On the other hand, when at least one captured image is recorded on the inserted memory card 90 in step ST63 (“YES” in step ST63), the digital camera 1 advances to step ST64 and determines whether a print order file has been already recorded on the inserted memory card 90 or not. In the case where no print order file is recorded on the memory card 90 (“NO” in step ST64), an image file of the largest frame number is read from the memory card 90 (step ST65), the function of the hold button of the electronic flash mode button 8c and the function of the erase button of the liquid crystal monitor button 8b which were invalidated in step ST62 are validated again (step ST66). The digital camera 1 shifts to the initial print setting screen (step GN64).

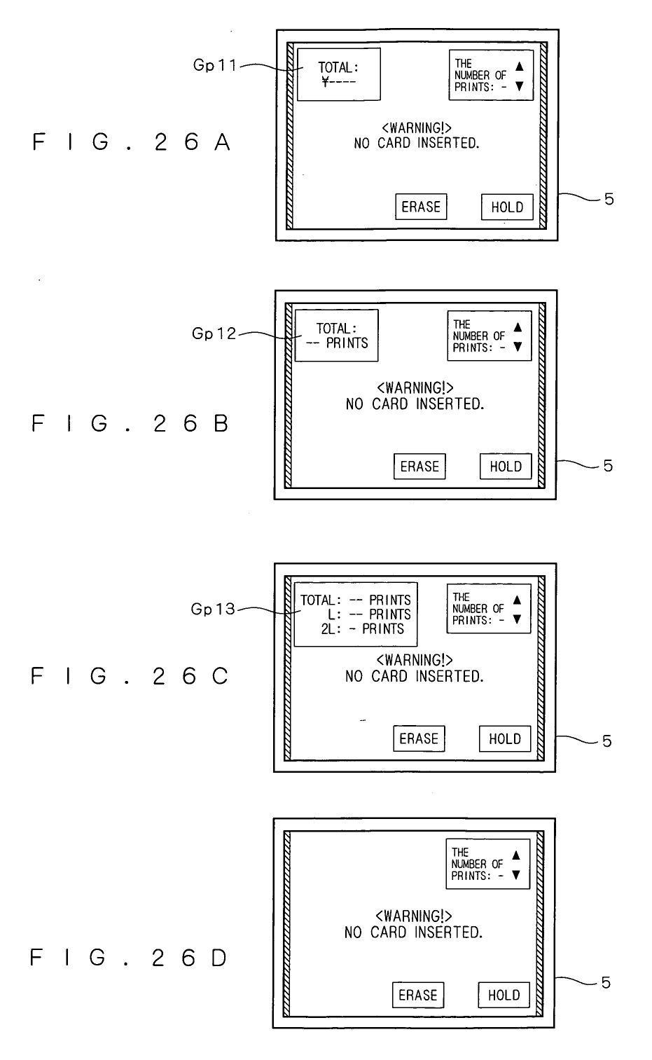

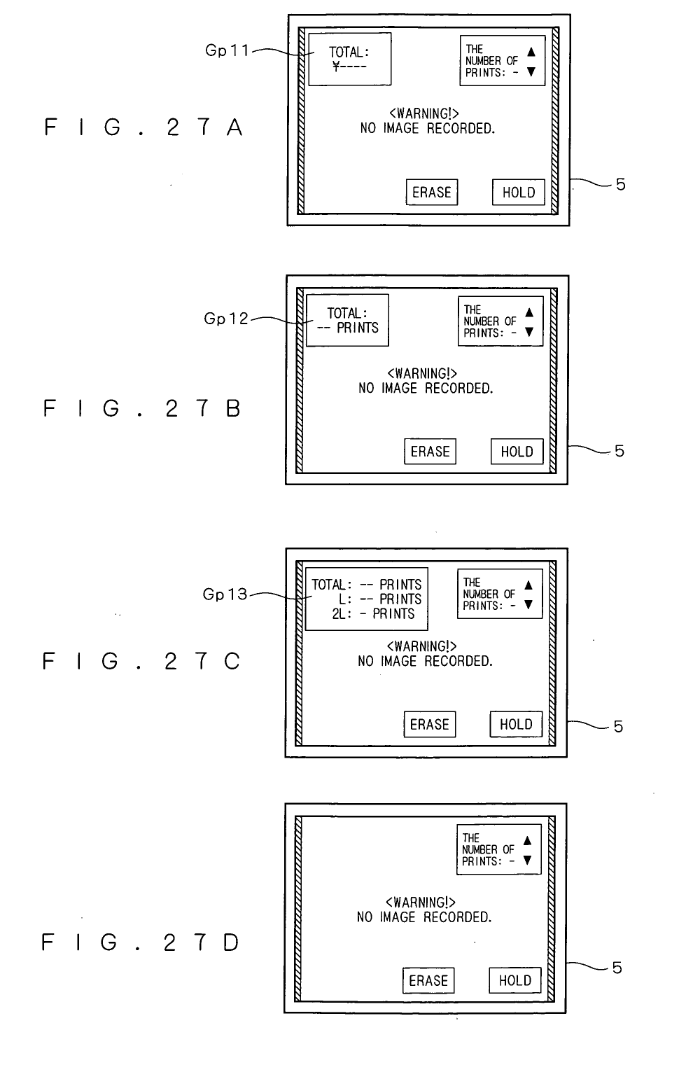

FIGS. 28A to 28D are diagrams showing examples of the screen displayed on the LCD 5 in the state GN64. In the state GN64, according to the display mode immediately before the memory card is taken out, any of the four kinds of warnings in FIGS. 28A to 28D is displayed.

The display screen of FIG. 28A is a screen displayed in the case where the indication Gp 11 (FIG. 17A) of total charge required for the total number of prints is displayed in the print setting screen immediately before the memory card 90 is taken out. The display screen of FIG. 28B is a screen displayed in the case where the indication Gp12 (FIG. 17B) of the total number corresponding to the total number of prints is displayed in the print setting screen immediately before the memory card 90 is taken out. The display screen of FIG. 28C is a screen displayed in the case where the indication Gp13 (FIG. 17C) of the total number corresponding to the total number of prints and the number of prints by size such as L size and 2 L size is displayed in the print setting screen immediately before the memory card 90 is taken out. Further, the display screen of FIG. 28D is a screen displayed in the case where the total number, total charge and the like are not shown in the print setting screen immediately before the memory card 90 is taken out. That is, also in the initial screen of the print setting screen in the state GN64, in a manner similar to the states GN62 and GN63, a screen is displayed in the display mode in which the display state immediately before ejection of the card is continued.

In the state GN64, as shown in FIGS. 28A to 28C, a captured image read from the memory card 90 is displayed on the screen, and the print setting operation on the captured image becomes acceptable. Since no print order file is recorded on the memory card 90, the numerical value of “0” indicating that the print settings have not been made is displayed in the indication boxes Gp11, Gp12 and Gp13. For example, the total number of prints is indicated as 0, and the total amount is indicated as ¥0. By visually recognizing the indication of “0” in the indication boxes Gp11, Gp12 and Gp13, the user can recognize that the print settings on an image recorded on the memory card 90 have not been made.

When it is determined that a print order file has been already recorded on the memory card 90 in step ST64 (“YES” in step ST64), a process of reading the print order file is performed (step ST67). On the basis of the print setting information included in the print order file, the overall controller 50 performs a process of calculating the total number of images on which printing settings have been already made (step ST68).

Referring now to FIG. 25, the overall controller 50 determines whether display of a charge is necessary or not (step ST69). The determination is made by checking whether a charge was displayed or not in the display state immediately before the card is taken out on the basis of the information stored in the RAM 50a. In the case where display of a charge is unnecessary (“NO” in step ST69), an image file of the largest frame number is read from the memory card 90 (step ST70), the function of the hold button of the electronic flash mode button 8c and the function of the erase button of the liquid crystal monitor button 8b, which were invalidated in step ST62, are validated again (step ST71), and the digital camera 1 shifts to a print setting screen (state GN65).

On the other hand, in the case where display of a charge is necessary (“YES” in step ST69), it is determined whether unit price information (registered information) is recorded in the memory card 90 or not (step ST72). If YES, the unit price information is read from the memory card 90 (step ST74). In the case where the unit price information (registered information) is not registered in the memory card 90, for example, an operation of inputting a setting of unit price information by the user is accepted, and the unit price information set by the user is employed (step ST73).

By executing an arithmetic process on the basis of the unit price information obtained in such a manner and the information recorded in the print order file, the overall controller 50 calculates a charge for printing in accordance with the print setting circumstances recorded in the print order file (step ST75).

An image file of the largest frame number is read from the memory card 90 (step ST76), the function of the hold button of the electronic flash mode button 8c and the function of the erase button of the liquid crystal monitor button 8b which were invalidated in step ST62 are validated again (step ST77), and the digital camera 1 shifts to the print setting screen (state GN66).

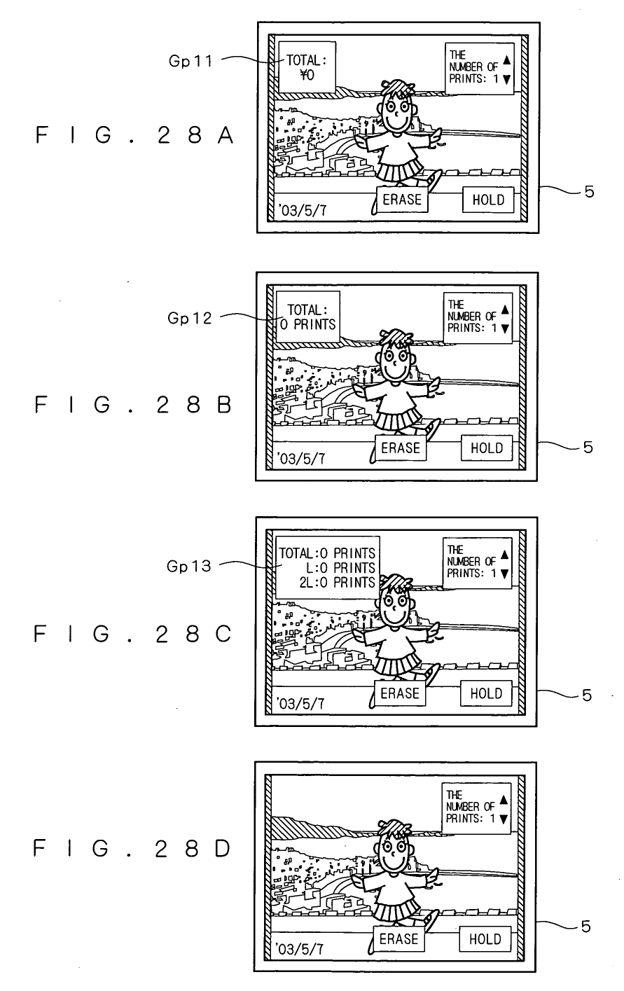

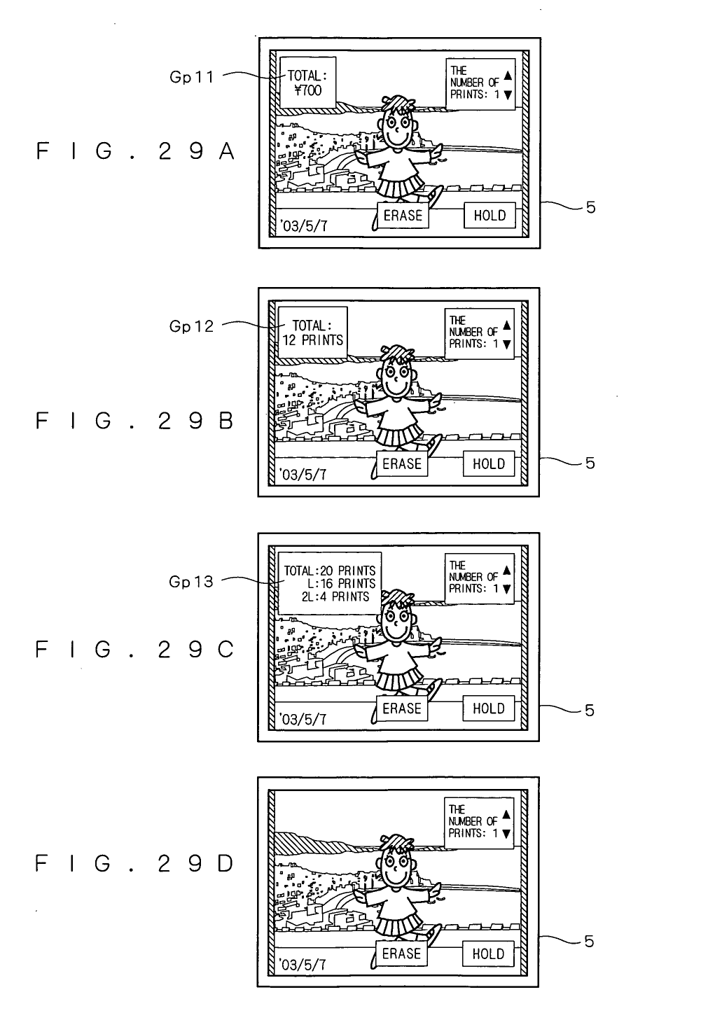

FIGS. 29A to 29D are diagrams showing examples of the screen displayed on the LCD 5 in the states GN65 and GN66. In the states GN65 and GN66, according to the display mode immediately before the memory card is taken out, any of the four kinds of warnings shown in FIGS. 29A to 29D is displayed. Specifically, in the state GN66, a print setting screen shown in FIG. 29A is displayed. In state GN65, any of print setting screens of FIGS. 29B to 29D is displayed according to the display mode immediately before the memory card is taken out.

In the display screen of FIG. 29A, a charge for printing which is calculated in step ST75 on the basis of information of the print order file recorded on the memory card 90 is displayed in the total charge indication box Gp11. In the display screen of FIG. 29B, the total number of prints calculated in step ST68 on the basis of the information of the print order file recorded on the memory card 90 is displayed in the total number indication box Gp12. In the display screen of FIG. 29C, total number calculated in step ST68 and the number of prints by kinds of print are displayed.

Therefore, also in the print setting screens in the states GN65 and GN66, the screen is displayed in the display mode in which the display state immediately before the memory card is taken out is continued. In any of the states GN65 and GN66, as shown in FIGS. 29A to 29D, a captured image read from the memory card 90 is displayed on the screen, and the print setting operation on the captured image is accepted.

In the case where a card is replaced in any of the states GN64, GN65 and GN66, the operations from the state GN61 are performed again.

As described above, the digital camera 1 of the preferred embodiment displays the print setting screen on the LCD 5 in the print mode and can display the total number of prints and a charge for printing on the print setting screen. Consequently, the user can easily grasp the state of general print settings (the total number of prints, print charges, and the like) which have been made on the memory card 90 until an arbitrary time point.

In the case where the memory card 90 is replaced when the print setting screen is displayed on the LCD 5 in the print mode, display of the print setting screen is continued, a print order file is read from the inserted memory card 90 interlockingly with insertion of the memory card 90 and, on the basis of information recorded in the print order file, the total number of prints and the total charge are displayed on the print setting screen. Therefore, while referring to the same print setting screen before and after the replacement of the memory card, the print setting operation can be continued. On the print setting screen, the information of the memory card 90 inserted in the digital camera 1 is always displayed. Thus, an erroneous operation can be prevented at the time of the print setting operation, and operability improves.

In the digital camera 1, also in the state where the memory card 90 is taken out, the print setting screen is continuously displayed and the print mode is continued. Thus, the user can grasp that the digital camera 1 operates in the print mode.

When the memory card 90 is taken out from the digital camera 1 or no captured image is recorded in the inserted memory card 90, an image to be subjected to print settings is not displayed on the print setting screen but a warning is indicated. Consequently, the user can easily grasp that the print setting operation cannot be performed.

When the memory card 90 is taken out, the digital camera 1 invalidates the function of the operation part 30 for performing the print setting operation. Therefore, even in the case where the print setting operation is performed by the user in the state where the memory card 90 is taken out, an illegal access operation or the like can be prevented from being executed.

### MODIFICATIONS

Although the preferred embodiment of the present invention has been described above, the present invention is not limited to the above.

For example, since the digital camera 1 of specifications for Japan has been taken as an example, a charge in the indication box Gp11 (FIG. 17A and the like) is indicated in Japanese Yen. In the case of manufacturing the digital camera 1 so as to meet specifications for a foreign country, for example, U.S.A., it is suitable to indicate the charge in U.S. dollars in the indication box Gp11.

The case where a recording medium is a memory card has been described above. The recording medium is not limited to a memory card but may be another recording medium such as a small magnetic disk card having therein a magnetic recording device or the like.

While the invention has been shown and described in detail, the foregoing description is in all aspects illustrative and not restrictive. It is therefore understood that numerous modifications and variations can be devised without departing from the scope of the invention.

1. A digital camera for recording a captured image on a removable recording medium, comprising:
a display for displaying an image;
an operating member for inputting a command;
a print setting part for updating a print order file to be recorded on said recording medium each time a print setting is made on an image recorded on said recording medium by using said operating member; and
a display controller for reading said print order file from said recording medium and displaying an order content on said display on the basis of information recorded in said print order file.

2. The digital camera according to claim 1, wherein
said display controller reads said print order file from said recording medium and displays the total number of prints on said display on the basis of the information recorded in said print order file.

3. The digital camera according to claim 2, wherein
said display controller displays the total number of prints by kind of printing recorded in said print order file on said display.

4. The digital camera according to claim 1, wherein
said display controller reads said print order file from said recording medium and displays a charge for printing on said display on the basis of the information recorded in said print order file.

5. The digital camera according to claim 4, wherein
said display controller displays said charge for printing on said display on the basis of information regarding printing recorded in said print order file and unit price information recorded on said recording medium.

6. The digital camera according to claim 5, wherein
said unit price information is information of unit price set for each kind of printing.

7. A digital camera for recording a captured image on a removable recording medium, comprising:
a display for displaying an image;
an operating member for inputting a command;
a print setting part for recording a print order file on said recording medium on the basis of input information supplied by a print setting operation using said operating member; and
a display controller for displaying a print setting screen on said display when the print setting operation is performed, reading said print order file from said recording medium interlockingly with insertion of said recording medium when said recording medium is replaced during display of said print setting screen, and displaying an order content in said print setting screen on the basis of information recorded in said print order file.

8. The digital camera according to claim 7, wherein
said display controller reads said print order file from said recording medium interlockingly with insertion of said recording medium and displays the total number of prints on said print setting screen on the basis of the information recorded in said print order file.

9. The digital camera according to claim 8, wherein
said display controller reads said print order file from said recording medium interlockingly with insertion of said recording medium and displays the total number of prints by kind of printing recorded in said print order file into said print setting screen.

10. The digital camera according to claim 7, wherein
said display controller reads said print order file from said recording medium interlockingly with insertion of said recording medium and calculates the total number of prints on the basis of print information for each image.

11. The digital camera according to claim 7, wherein
said display controller continuously displays said print setting screen also in the case where said recording medium is taken out while said print setting screen is displayed.

12. The digital camera according to claim 7, wherein
when said recording medium is taken out while said print setting screen is displayed, said display controller invalidates input information which is inputted by the print setting operation using said operating member.

13. The digital camera according to claim 7, wherein
at the time of displaying said print setting screen on said display in the case where said recording medium is inserted, said display controller reads and displays an image which is recorded on said recording medium and is an object of said print setting operation.

14. The digital camera according to claim 13, wherein
when an image which is read interlockingly with insertion of said recording medium and is an object of said print setting operation is not recorded on said recording medium, said display controller displays a warning on said display.

15. The digital camera according to claim 7, wherein
said display controller reads said print order file from said recording medium interlockingly with insertion of said recording medium and, on the basis of information recorded in said print order file, displays a charge for printing in said print setting screen.

16. The digital camera according to claim 15, wherein
said display controller calculates said charge for printing on the basis of information regarding printing recorded in said print order file and unit price information recorded on said recording medium.

17. The digital camera according to claim 16, wherein
said unit price information is information of unit price set for each kind of printing.
